(19) United States
(12) Patent Application Publication
(10) Pub. No.: US 2005/0281470 A1
(43) Pub. Date: Dec. 22, 2005

(54) System and method for streaming media

(76) Inventor: Michael A. Adams, Las Vegas, NV (US)

Correspondence Address: DITTHAVONG & CARLSON, P.C., Suite A, 10507 Braddock Rd, Fairfax, VA, 22032, US

(21) Appl. No.: 11/038,019

(22) Filed: Jan. 18, 2005

Related U.S. Application Data
(63) Continuation of application No. 10/025,675, filed on Dec. 26, 2001, now abandoned.

(51) Int. Cl. G06K 9/36

(52) U.S. Cl. 382/232

(57) ABSTRACT

A system and method for streaming media transmission employ a compression technology in which null pixel blocks are drastically compressed an additional null pixel blocks are created in the video signal. Various applications of the invention are described, including recorded media distribution, live streamed media distribution, and email distribution.

### RELATED APPLICATIONS

The present application claims the benefit of U.S. Provisional Patent Application Ser. No. 60/176,990, entitled “MEDIA TRANSMISSION SYSTEM” filed on Jan. 19, 2000 by Dr. Michael A. Adams, the contents of which are hereby incorporated by reference.

The present application claims the benefit of U.S. Provisional Patent Application Ser. No. 60/203,555, entitled “METHOD AND APPARATUS FOR NETWORKED COMMUNICATION” filed on May 11, 2000 by Dr. Michael A. Adams, the contents of which are hereby incorporated by reference.

The present application claims the benefit of U.S. Provisional Patent Application Ser. No. 60/210,872, entitled METHOD AND APPARATUS FOR NETWORKED COMMUNICATION” filed on Jun. 8, 2000 by Dr. Michael A. Adams, the contents of which are hereby incorporated by reference.

### FIELD OF THE INVENTION

This invention relates in general to computer hardware and associated software for providing media for transmission, and more specifically, to a computer hardware and associated software system configured to create and support the distribution and playing of Internet-based video, audio, and/or text media transmission.

### BACKGROUND OF THE INVENTION

The Internet, a large packet-switched network that connects millions of users worldwide, has made electronic communications and commerce available to the general public. Internet usage has exploded over the past several years, especially in the usage of the World Wide Web and e-mail. The usage of multimedia on the Internet has also exploded, with web pages and e-mail being formatted to include audio and video files that can be downloaded and then played on a “media player,” which is software configured to present that media to a user.

These downloaded media files are in formats that include MPEG (Motion Picture Experts Group) and AVI (Audio Video Interleaved, also known as Microsoft Video for Windows). Like all other files on the Internet, these media files are each broken into a data stream composed of packets. Each packet contains a packet header and a payload (the data portion). The packet header has fields that describe the specific contents of the payload. Because media files are often quite large, time and memory limitations require many live-broadcast media presentations to be viewed before the media file is completely downloaded from the Internet. Accordingly, several companies have been developing streaming media players that allow a user to view the media during delivery.

Currently the top three providers of streaming media generally require the use of “plug-in” technology for desktop PCs, under which a user is required to download a proprietary media player (i.e., a media player embodying privately owned technology) to each desktop PC as plug-in software (a plug-in). A plug-in is a type of computer software application that tightly integrates with a larger application, in this case an Internet browser, to add a special capability to that larger application. The plug-in players must be installed (e.g., integrated with browsers), and then used by the browsers to display and/or play the media files.

Three particular programs presently predominate the market for streaming media. According to November 1999 data from A. C. Nielsen, REALNETWORKS'™ REALPLAYER™ streaming media player garnered the majority of the usage with use by approximately 12.1 percent of the active Internet universe. APPLE COMPUTER's™ QuickTime media player was used by approximately 7.4 percent of Internet users, and MICROSOFT's™ Windows Media Player was used by approximately 3.2 percent of Internet users.

It would therefore appear that over 60% of Internet users either cannot or prefer not to download and install a plug-in media player in their desktop PCs. Furthermore, because these media players use different formats for their payload (i.e., the media itself), those Internet users who do download plug-in players might have to download different plug-in players for each media format that they wish to play. Additionally, users that choose to download a plug-in media player, must also download upgrades to the player whenever the streaming media company upgrades its player to provide new tools or media formats.

In the case of media-based (i.e., audio and/or video) email, current email software using plug-in technology requires users to download an entire media file (a binary file) prior to playing the media. Users with low bandwidth connections (e.g. 28.8 kbaud modems) are therefore burdened by lengthy download times prior to playing the media.

Typically, the video signal being transmitted to a destination computer system over the Internet is compressed to improve transmission speeds. One common type of compression is known as MPEG because MPEG was proposed as a standard by the Moving Pictures Expert Group. MPEG employs a variety of techniques to compress a video signal, including dividing the video into blocks of 8×8 or 16×16 pixels and processing the blocks by a discrete cosine transform (DCT), so that 16×16 pixel blocks, which normally should consume about 6144 bits, are compressed into about 100-125 bits. One of MPEG's compression techniques involves intraframe analysis, in which corresponding blocks of pixels between frames are compared for any differences. If a pixel block is the same between two frames (referred to as a “null pixel block” because the difference is zero between the pixel block and the corresponding pixel block of the preceding frame), then the pixel block is replaced by a short 7-bit descriptor. Accordingly, 16×16 pixel blocks are compressed from 6144 bits to 7 bits if null and 100-124 bits if not null. Despite all of the compression techniques employed by MPEG, the result is still too large to be acceptable for low bandwidth connections such as 28.8 kBaud or 56 kBaud.

Accordingly, there exists a need for a network-based hardware and associated software system, and related methods, for providing media transmission to and/or between clients across a network, especially over low bandwidth connections. Furthermore, there exists a need for the computer hardware and associated software system necessary to create and support the transmission of the Internet-based video, audio, and/or text media. The present invention satisfies these and other needs, and provides further related advantages.

### SUMMARY OF THE INVENTION

These and other needs are addressed by the present invention, which provides a video compression technology that compresses null pixel blocks down to as tiny as a single bit, thereby achieving drastic compression ratios suitable for low bandwidth connections. In particular, an extra bit is allocated for every pixel block in the video signal. If the pixel block is null, then the bit is set to one value (e.g. 1) and the entire remainder of pixel block is discarded as redundant. On the other hand, if the pixel block is not null, the bit is set to the other value (e.g. 0) to signal that a pixel block with new values is to follow.

The provision of an overhead bit for non-null pixel blocks runs counter to standard industry practices because the video signal is actually expanded, not compressed, for non-null pixel blocks. The savings in bits for null pixel blocks, however, more than compensates for the bit of extra overhead in non-null pixel blocks, as long as about 6% of the pixel blocks of a video frame are null. Since 2% to 25% of the pixel blocks of most video signals are typically null, this technique by itself is advantageous for a majority of the video signals.

To further leverage the advantage of the single-bit representation for null pixel blocks, additional processing is performed on the video signal to increase the number of null pixel blocks. One technique is referred to as “image stabilization,” in which small movements of an image between frame are represented a null pixel block (i.e. no movement) plus an indicator of how much the block is shifted. Another technique employed is hysteresis filtering, which identifies those pixel blocks that differ only by noise (i.e. random variations in the image) and treats them as additional null pixel blocks; to restore the look and feel of the image, noise is reintroduced into the pixel block upon decompression.

In other embodiments, the present invention provides network-based hardware and associated software system, and related methods, for creating, supplying, and playing Internet-based media. Other embodiments of the present invention can provide a user with the ability to store, retrieve, and manage multi-media files in an easier, friendlier, more consumer and business-oriented manner. These embodiments can make Internet commerce user-friendlier by providing businesses and consumers with the ability to manage their multi-media files in a manner that provides quick and easy access to each multi-media file in a multimedia archive (i.e., a related database and file storage facility configured for storing and distributing media files). In addition, these embodiments provide easy methods for preparing and loading the multi-media files into the multimedia archive.

Still other objects and advantages of the present invention will become readily apparent from the following detailed description, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A depicts a basic video compression network architecture in accordance with one embodiment of the present invention.

FIG. 1B is a flowchart illustrating video compression in one embodiment of the present invention.

FIG. 1C is a flowchart illustrating video decompression in one embodiment of the present invention.

FIG. 2A depicts a Java flow that illustrates the layered architecture of a Java application.

FIG. 2B depicts a basic director page in one embodiment of the present invention.

FIG. 3 depicts a “Who's On Now” page in one embodiment of the present invention.

FIG. 4 is a flowchart of a bimodal billing processing in one embodiment of the present invention.

FIG. 5 depicts a userid and password protection interface in one embodiment of the present invention.

FIG. 6 depicts a Pay Event page in one embodiment of the present invention.

FIG. 7 depicts a Live Screen page in one embodiment of the present invention.

FIG. 8 depicts a “Who's On Now” page in one embodiment of the present invention.

FIG. 9 depicts a Pay Event page in one embodiment of the present invention.

FIG. 10 depicts a broadcast client in one embodiment of the present invention.

FIG. 11 is a flowchart of a customer's operations in one embodiment of the present invention.

FIG. 12 depicts a Chat Handle page in one embodiment of the present invention.

FIG. 13 depicts a “Who's On Now” page in one embodiment of the present invention.

FIG. 14 depicts a “Who's On Now” page when no operators are available in one embodiment of the present invention.

FIG. 15 depicts an Operator page for interfacing with a Forum Operator in one embodiment of the present invention.

FIG. 16 depicts an e-mail page in one embodiment of the present invention.

FIG. 17 depicts an Operator page for interfacing with a Forum Operator in one embodiment of the present invention.

FIG. 18 depicts a Survey page in one embodiment of the present invention.

FIG. 19 depicts an e-mail page in one embodiment of the present invention.

FIG. 20 is a flowchart of a start up procedure in one embodiment of the present invention.

FIG. 21 is a flowchart of a get services procedure in one embodiment of the present invention.

FIG. 22 is a flowchart of a get user procedure in one embodiment of the present invention.

FIG. 23 is a flowchart of a register user procedure in one embodiment of the present invention.

FIG. 24 is a flowchart of a get configuration procedure in one embodiment of the present invention.

FIG. 25 is a chart of member services procedure in one embodiment of the present invention.

FIG. 26 is a depiction of a multimedia archive in one embodiment of the present invention.

FIG. 27 is a chart of a file manager procedure in one embodiment of the present invention.

FIG. 28 is a chart of a video e-mail procedure in one embodiment of the present invention.

FIG. 29 is a chart of a contest services procedure in one embodiment of the present invention.

FIG. 30 depicts a global network architecture in one embodiment of the present invention.

FIG. 31A depicts a data center architecture in one embodiment of the present invention.

FIG. 31B depicts a Point-of-Presence (POP) in one embodiment of the present invention.

FIG. 32 depicts a hardware system upon which an embodiment of the present invention may be implemented.

### DESCRIPTION OF THE PREFERRED EMBODIMENT

A system, method, and software for multimedia network transmission are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Technical Overview

Embodiments of the present invention may be implemented with a web-based hardware and software system infrastructure for supporting multimedia communications in a networked environment. This infrastructure includes three distinct aspects, which will be referred to as the network architecture, the multimedia archive, and video capture. These three aspects are useful for supporting a media transmission system including one or more embodiments of networked-based media distribution products, which will be referred to as Recorded Media Distribution, Live-Streamed Media Distribution, Customer Support Live-streamed Media Transmission, and Streamed Media Transmission.

The network architecture, multimedia archive, and video capture each provide support for networked multimedia communications. Furthermore, combinations of the three with each other, and/or with the described networked-based products, each offers technologies for supporting networked communications.

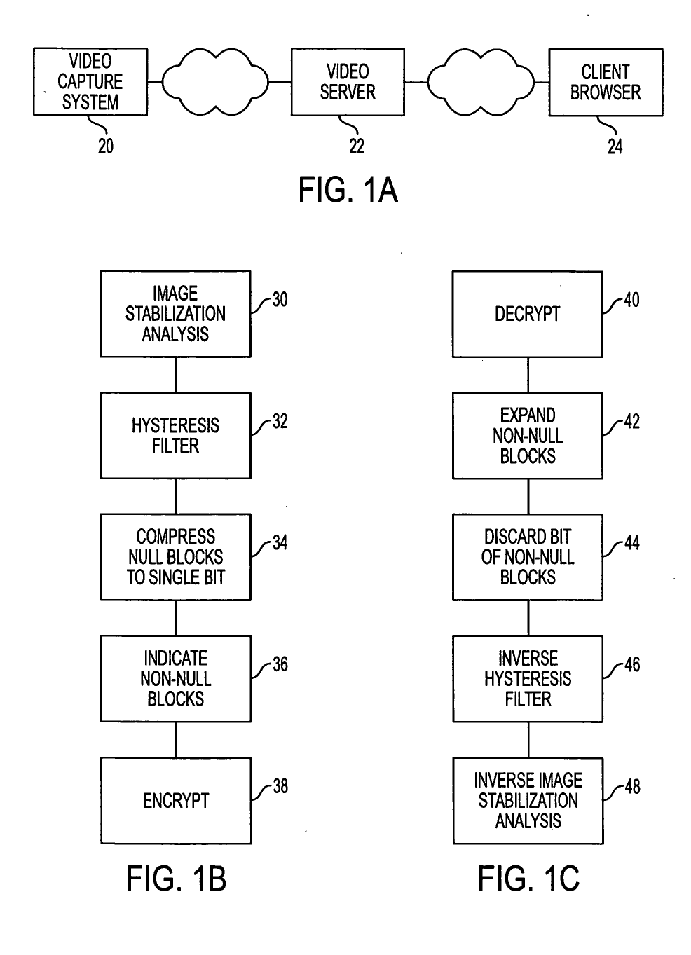

FIG. 1A depicts the network architecture of a distributed media transmission system. The distributed media transmission includes a video capture system 20, which can be implemented as a computer system with a digital video camera for taking moving pictures of a person such as an operator or a scene. Preferably in live transmission situations, the captured video signal, which may be in an industry standard Source Input Format (SIF) of 352×240 pixel frames at the 30 frames per second, is pre-compressed using MPEG or similar technique and transmitted to a video server 22. Pre-compressing the captured video signal before transmitting to video server 22 has at least two advantages. First, the computing requires for the MPEG or similar compression is offloaded onto the video capture system 20 so that the video server 22 is freed up to supply more clients with the video signal. Second, the pre-compressed video signal consumes less bandwidth.

The video server 22 is responsible for further compressing and storing the video signal in a plurality of pre-specified formats, corresponding to combinations of picture sizes (e.g. 352×200 or 600×480) and connection speeds (28.8K, 56K, DSL, etc.). Operation of the second compression phase is illustrated in FIG. 1B, where additional null blocks are created (steps 30 and 32) and then replaced by as little as a single bit (steps 34 and 36).

At step 30, an image stabilization analysis is perform to identify those pixel blocks that differ from corresponding pixel blocks in the preceding frame by an offset. If so, the pixel block is replaced with a null pixel block and an indication of the offset. This processing is useful when the main change in the video frames is a panning motion.

At step 32, a hysteresis filter is applied the pixels to determine those pixel blocks that differ from corresponding pixel blocks in the preceding frame only by a certain level of noise that exceeds a preset hysteresis threshold. In this case, the pixel block is replaced with a null pixel block and an indication of the noise. The hysteresis threshold theoretically ranges from 0% (all changes are significant non-noise) to 100% (all changes are noise). It has been found that a hysteresis threshold as high as 20% yields acceptable results.

At step 34, all the null pixel blocks, whether original or created in steps 30 and 32, are compressed into one or more bits. Preferably the compression of null pixel block is down to a single bit, but advantages still accrue for a plurality of bits if the number of bits is less than the number of bits in the MPEG filter. To distinguish non-null pixel blocks, a corresponding overhead bit with another value is added to the non-null pixel blocks in the output in step 36.

To implement a security mechanism to protect valuable videos such as popular movies, the compressed media stream is optionally encrypted using the IP address, URL, or other network identifier of the video server 24 as the key in step 38.

Referring back to FIG. 1A, the video server 22, in response to a request from a client browser 24 that indicates the desired media format, causes a Java™ applet (not shown) to be transmitted for the client browser 24 to execute. Upon execution, the Javaυ applet performs the steps shown in FIG. 1C. Use of the Java™ advantageously removes the need for users to have previously downloaded a media player plug-in, thereby providing convenience to the users and ensuring that the most recent player is always being used.

Referring now to FIG. 1C, the compressed media stream received by the client browser 34 is decrypted using the IP address, URL, or other network identifier of the sending video server 24 as the key in step 40. This prevents the client from saving the video stream and resending to somewhere else, because the network identifier of the video server 24 will be different.

At step 42, the single bit (or other specified value) is converted back into a null pixel block if the bit is set to one preset value. Otherwise if the bit (or other specified value) is set another preset value, the bit is simply discarded in step 44 because a non-null block is present.

In steps 46 and 48, some of the null pixel blocks are converted into non-null pixel blocks. For example at step 46, if the null pixel block came from a noisy pixel block as determined by the hysteresis filter, the noise is randomly generated and added to the null pixel block to create a noisy pixel block, thereby duplicating the visual effect of the original pixel block, even if the noise added back is not identical to the noise that was removed. At step 48, the offset information is used to shift the null pixel block to reproduce the original panned pixel block.

### I. Media Transmission System

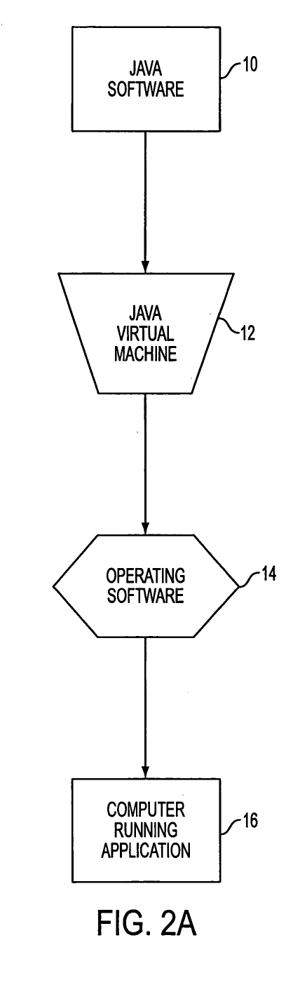

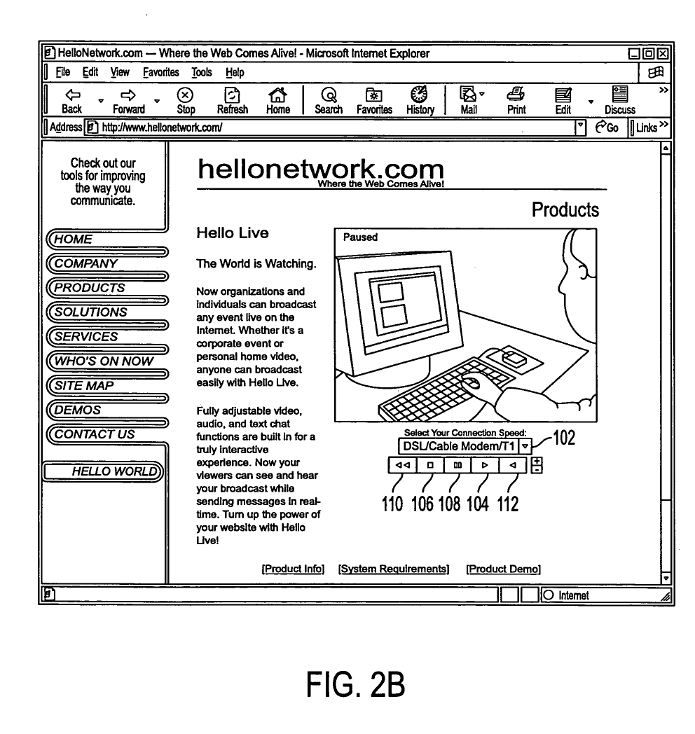

A media transmission system is provided for the streamed delivery of media to a user using a browser, typically without the use of a plug-in for that browser. With reference to FIG. 2A, the preferred embodiments use web pages that include embedded references to Java software 10 to perform this function. Each such web page can be stored out on the network, or on a local disk. When the browser sees these references, it loads the Java software (called an “applet”) transparently and securely. The applet is then processed by a Java virtual machine 12, which is a set of software tools built into the user's browser. Typically, the Java virtual machine first performs security checks, and then runs the applet 10, which appears and interoperates inside the browser. Under the control of the Java software, the computer's operating system 14 provides machine-specific support for many of the actual operations and interactions called for by the Java software.

The specific Java software 10 that is downloaded directs the Java virtual machine 12 to control the operating system 14, and thereby the computer, such that the computer runs the desired software 16, which decompresses as described above and plays the video stream. Thus, the user is provided with a streaming media software device, which is preferably interactive. The Java virtual machine serves as consistent platform on different kinds of computers and operating systems, so that the same Java applet runs in browsers on PCs, Macs, UNIX™ workstations, Network Computers, and elsewhere. This streaming media device can optionally be configured to receive and play various types of data audio, video and/or text information. Preferably, the audio, video and/or text information is provided and received in a compressed and/or encrypted format that maximizes data delivery efficiency and/or security considerations.

### A. Recorded Media Distribution

One embodiment of the present invention involves recorded media distribution. An event web page offering a first, recorded media embodiment of the media transmission system is depicted in FIG. 2 using the product and/or service of the first embodiment, a web site visitor (i.e., a user) can see and/or hear, a recorded broadcast without leaving the web site and without downloading a plug-in. Additionally, recorded media distribution makes E-commerce more user-friendly by providing bimodal billing capabilities, allowing the broadcaster to charge each user for the broadcast, either by the minute, by the event, or by a monthly subscription.

Using a Java-enabled client that was dynamically loaded to web browser of the visitor to the web page eliminates the needs to download, install, or maintain plug-ins or other downloaded software. Recorded media distribution allows one to encode footage in a streamlined, easily accessible digital format for offering a “Video jukebox” on a web site.

### 1. Recorded Media Transmission's User Experience

The user of a web site with recorded media distribution can be presented with a hyperlink on a World Wide Web site, whereupon the media is distributed to the user when the user activates the link, or the broadcast can be set up to start as soon as the page is loaded. The user, using provided the tool set, controls the operation of recorded media distribution. For example, using a size control, the user can control the size of the window on the user's web browser.

The tool set also provides VCR-like functionality to the user, and can be implemented in various forms. One implementation offers a basic and an enhanced tool set. In addition to the tool set, the user can be presented with a speed control 102 for controlling choices as to what speed the user would like to view the recorded broadcast. The recorded broadcast can then be encoded at any various different speeds or frame rates to provide the end user with a viewing experience that best matches the capabilities of the user's environment. For example, a 28.8K broadcast can be used for providing service to lower speed modem users.

The basic tool set includes the following standard controls: Start 104, which plays the video; Stop 106, which stops the video, Pause 108, which pauses the video; Rewind 110, which rewinds the video to the beginning; and Volume 112, which controls the volume.

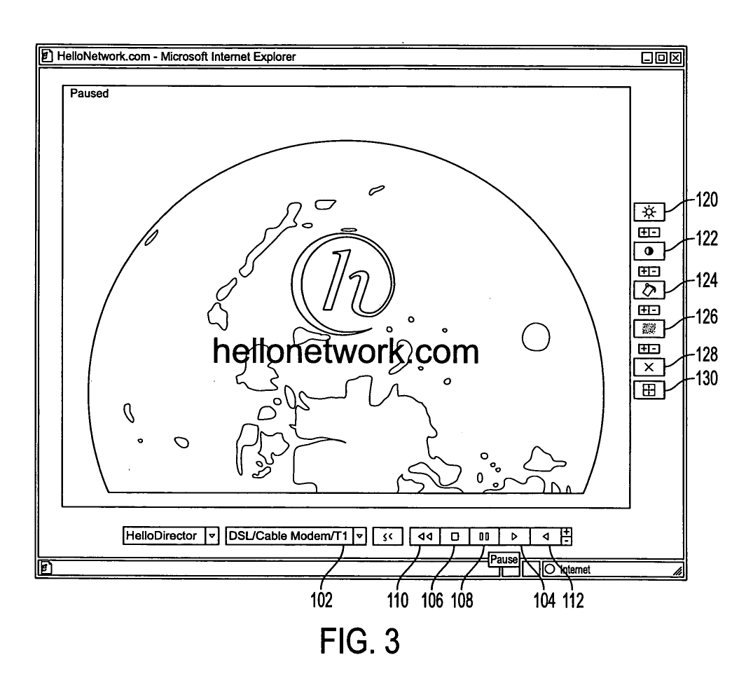

With reference to FIG. 3, the user can optionally be provided with an advanced tool set that gives the user even more control over the user's experience. With the advanced tool set, the user has use of all the controls discussed in the basic tool set (i.e., Speed Control 102, Start 104, Stop 106, Pause 108, Rewind 110, and Volume 112). In addition, the user is given additional controls and functions. In particular, the advanced tool set implementation includes the following controls: Brightness 120, which adjusts the brightness of the video; Contrast 122, which adjusts the contrast of the video; Saturation 124, which adjusts the video color saturation; Dithering 126, which adjusts the video dithering; Default 128, which resets the video setting to the defaults in effect at the time the video was encoded; and Video Size 130, which toggles between doubling the video size from the size at which it was originally encoded and resetting the video from the doubled size to the original size.

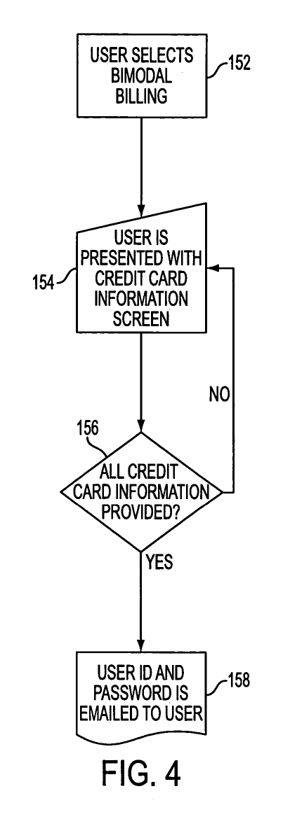

With reference to FIG. 4, an embodiment for providing media in an e-commerce setting is illustrated. Preferably, the user is required to purchase the appropriate amount of time or usage required prior to receiving the media in this embodiment. Thus, prior to a broadcasting web site's broadcast of pay-for-access media (e.g., recorded video) to a user, the user first selects to use the billing process 152. In response to a request 154, the user provides payment information, such as credit card information. The payment information is verified 156 for completeness, and preferably for credit worthiness. The user is then e-mailed 158 back a userid and password for that event, or for that web site's events overall.

This bimodal billing allows the broadcaster to present billing options to their users. Preferably, the options include per-minute, per-event, and per-month payment choices. Among these options are the user can thus find preferred choices for access professional services online, chatting with celebrities, or be part of exclusive broadcasts.

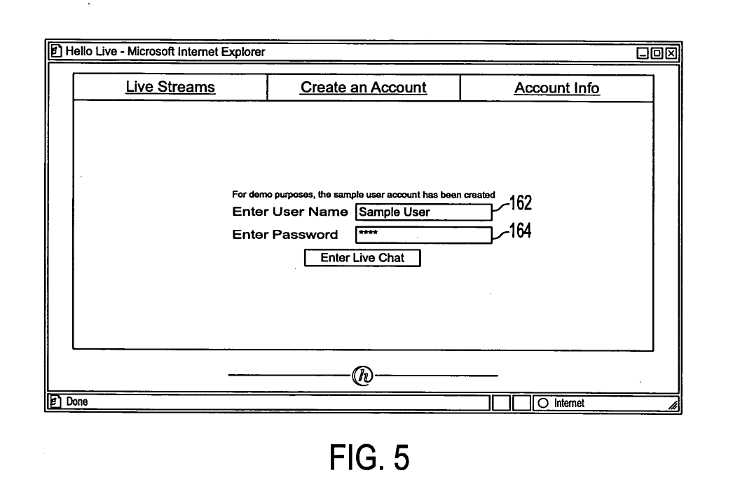

Once the user has acquired the userid and password for the event, the user goes to the World Wide Web site and is presented with a login screen, depicted in FIG. 5, which includes input fields for userid 162 and password 164. Options are provided for users to arranging for payment, or to review account information.

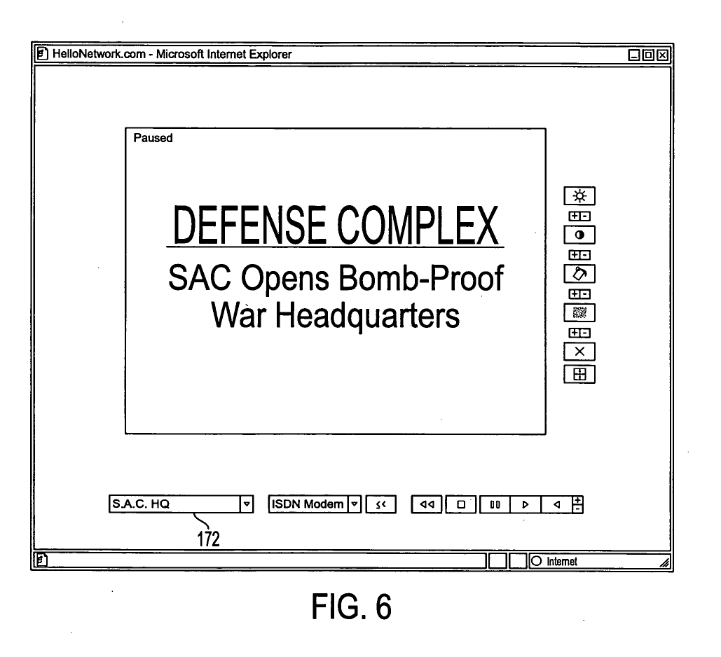

As seen in FIG. 6, after logging in, the user is provided with the first embodiment's event page, including the various controls described above. The user then selects the media video that the user wishes to view in a selection field 172 and is presented with control over the audio, video, and other capabilities.

### 2. Administration of Recorded Media Transmission

Administrators may control the usage of recorded media distribution. Administrators are able to do create a new administrator account, giving the new administrator the same capabilities as an existing administrator. Administrators are also able to list, edit, and view the status (e.g. logged on or off) and role (e.g. administrator, operator, user) of all the administrators as well as print detailed reports regarding the operators, administrators, users, and other vital statistical information, such as session chat transcripts. Administrators can also terminate one's sessions, edit a list of recorded media URLs available to the user, and do other customization, such as that of the front end.

### B. Live-Streamed Media Distribution

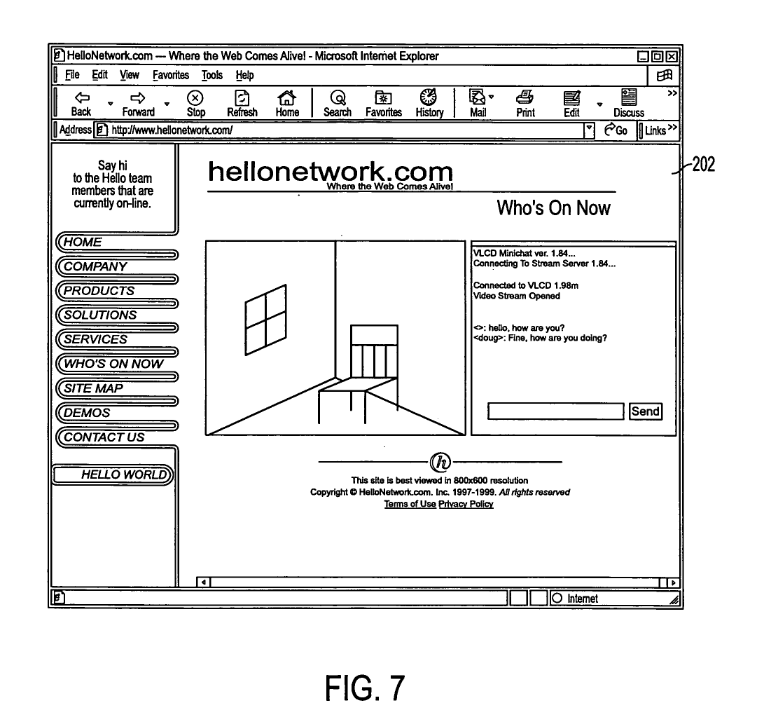

Another embodiment of the present invention pertains to live-streamed media distribution. An event web page offering a embodiment of the media transmission system is depicted in FIG. 7. By using the live-streamed media distribution's product or service, web site visitors can see, hear, and interact with a broadcaster without leaving the web site, and typically, without downloading a plug-in type software.

Live-streamed media distribution shares some aspects in common with the first embodiment. In particular, live-streamed media distribution makes e-commerce more user-friendly by providing bimodal billing capabilities, allowing the broadcaster to charge each user for the broadcast, either by the minute, by the event, or by a monthly subscription. Using a Java-enabled client dynamically loaded in the web page's visitor's web browser eliminates the needs to download, install, or maintain plug-ins or other downloaded software.

### 1. Live-Streamed Media Distributions's User Experience

To begin use of live-streamed media distribution, the user can be presented with a hyperlink on a World Wide Web site, or the broadcast can be set up to start as soon as the user loads a particular World Wide Web page 202. Preferably, the size of the window on the user's web browser is controlled by the broadcaster, as is the speed at which the user receives the broadcast. The user can then view the live broadcast in the web page that he/she was viewing. Additionally, the user has the ability to chat with the broadcaster, as well as the other viewers.

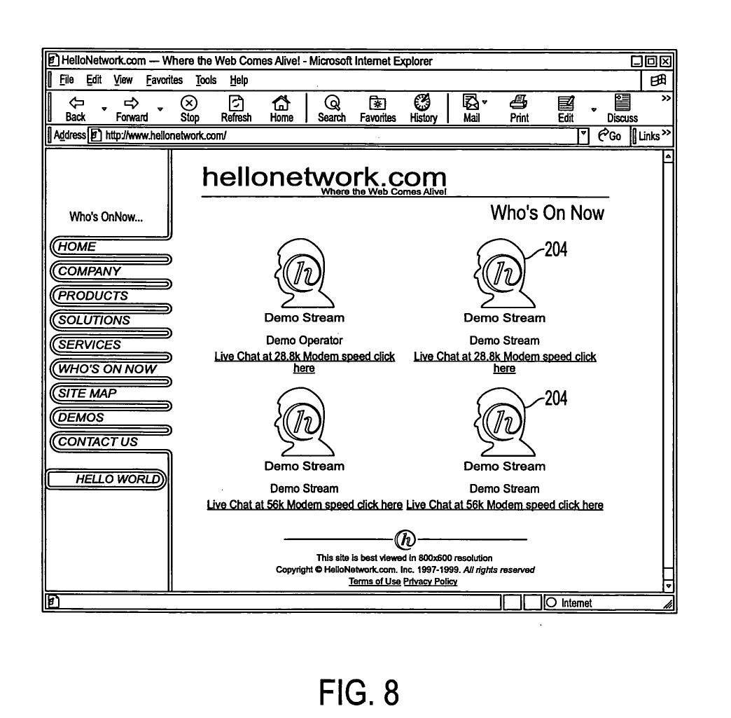

If there is more than one broadcast that is accessible from a single World Wide Web site, the system administrators (and/or the broadcasters) have the ability to present the user with the option of choosing among the different broadcasts that are currently ongoing and live. This is done using “Who's On Now” web page technology, depicted in FIG. 8. This web page presents the user with selections 204 from various available live broadcasts, which the user then chooses from among.

### 2. Live-Streamed Media Distribution used for Streaming Commerce

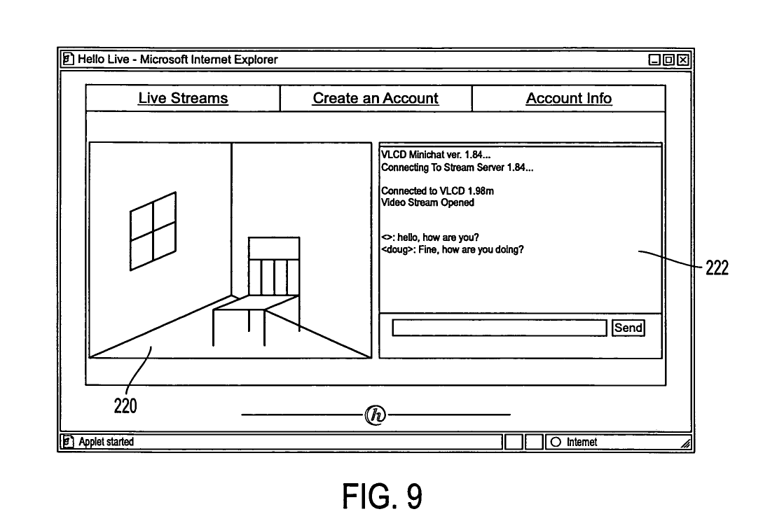

With live-streamed media distribution used for streaming commerce, users can be provided with billing options for media streaming events. Similar to recorded media distribution, the user first must purchase the appropriate amount of time required for the event, for broadcasts where the broadcaster is charging for the broadcast, and the user is then e-mailed back a userid and password for that event, or for that website's events overall. The flow and operation of payment is similar to that of recorded media distribution, and reference is made to that discussion, above. With reference to FIG. 9, upon the completion and verification of payment, the user then enters the event, and is presented with audio, video 220, and chat 222 (i.e., interactive written communication) capabilities.

### 3. Broadcast Control of Live-Streamed Media Distribution

Preferably, the broadcaster has a “Broadcast” client system installed on a standard PC (or similar machine). The Broadcast client is software preferably configured to broadcast the broadcaster's selected media (i.e., audio, video and/or chat) to a server configured support transmission of the media. The broadcaster's PC preferably includes a standard desktop PC camera and microphone to generate audio and video signals for transmission. However, other sources of audio and/or video signals for the broadcaster's use could be provided.

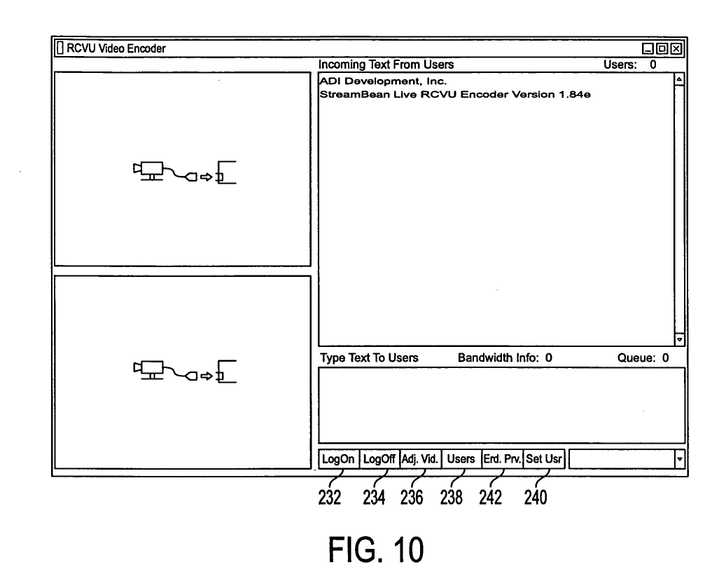

With reference to FIG. 10, the Broadcast client interfaces to the desktop PC camera (or other video sources), and preferably provides the broadcaster with standard camera control features, such as brightness, contrast, etc., either through a standard windows interface or through an interface provided with the camera. The Broadcast client preferably provides the following capabilities to the broadcaster: Log On 232, which starts the live broadcast by connecting the Live Broadcast client to the assigned Live Broadcast server; Log Off 234, which ends the live broadcast by disconnecting the Live Broadcast client from the broadcast server; Adjust Video 236, which adjusts the camera features such as color, brightness, contrast, etc.; Users 238, which provides the broadcaster with a listing of all the viewers that are currently logged into the broadcast; Set User 240, which provides the broadcaster the ability to select a user and interface and interact with that user in a private session. This blocks all other users from viewing the broadcast, and the text-based messages that are going between the broadcaster and the selected user; End Private 242, which provides the user with the ability to end the private session with the selected user. All other viewers can then view and interact with the broadcaster.

### 4. Administration of Live-Streamed Media Distribution

While broadcasters will typically control individual media-stream content, administrators control the usage of live-streamed media distribution. Administrators for live-streamed media distribution are able to do the same (or equivalent) functions as those for recorded media distribution. Administrators for live-streamed media distribution are also able to change the chat message that the users see when they enter a session with an operator, as described above.

### C. Customer Support Live-Streamed Media Transmission

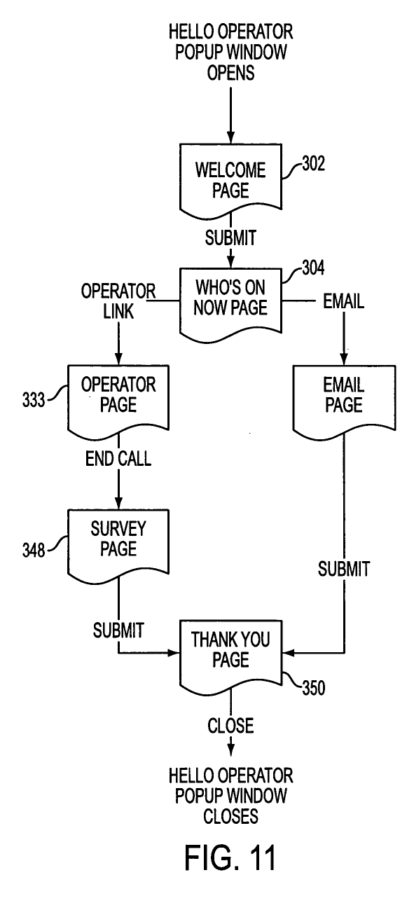

A usage flow path for still another embodiment of the media transmission system, relating to customer support live-streamed media distribution, is depicted in FIG. 11. By using customer support live-streamed media distribution's product or service, web site visitors can see, hear and/or interact with a broadcaster without leaving the web site, and typically, without downloading a plug-in type software. Customer support live-streamed media distribution has the power to make e-commerce user-friendlier by providing the personal service usually associated with traditional brick-and-mortar retailers.

Customer support live-streamed media distribution shares some aspects in common with the embodiments. In particular, using a Java-enabled client dynamically loaded in the web page's visitor's web browser eliminates the needs to download, install, or maintain plug-ins or other downloaded software. Other aspects of the previously described embodiments can be used in variations of customer support live-streamed media distribution.

### 1. Participant Classes and Characteristics

Various embodiments, as described above, involve different numbers and types of participants. Because the present embodiment involves a relatively large number of participants, their typical roles will be more thoroughly discussed.

The client is a company, typically having an e-commerce site. The client will typically use the interactive live-streamed media transmission embodiment to provide interactive customer assistance by a client operator (see below) to a user/customer (see below) during the customer's shopping and purchasing experience.

A user/customer will typically access the system of the present embodiment via the client's website. These users are end-users that invoke the system to interact with a client operator, preferably via text-based chat, while preferably also receiving audio and video media (typically live media of the customer operator) from client operators. The user will typically interact with the client operator for some type of assistance. The client operator optionally can have the user's browser open a new page to a customer operator's selected URL. Typically, the user's level of experience with web technology is as an individual with very little technical knowledge, but that has a basic proficiency in using a web browser and the Internet. The user's interface should account for this. Under the system, the user has no direct access to the system, other than through the request sent to initiate the media and text-based interaction.

Client operators will preferably access the system on a periodic basis several times a week for an average of 8 hours per day. The client operators will broadcast video and/or audio from their computer system to users. Preferably, they will also interact with end-users directly via the text-based chat. Client operators will generally have minimal information system experience, and their training on the system will typically be at a minimum. Preferably, the client operator's interface accounts for this with a friendly interface. Client operators can be located anywhere geographically with secure Internet access. They will have operator-level access to their client specific profile only

Client Administrators will preferably access the system on a daily basis for at least a few hours a day when COs are logged in. They perform all administrative duties for configuring client-wide parameters and operator configurations for a specific client. They preferably have at least one month experience using web-centric information systems, but they need not be technical individuals. They also preferably have at least three months experience in “call center” type operations. Their user interface preferably accounts for this. Client operators can be located anywhere geographically with secure Internet access, and they will have administrator-level access to their specific client profile only.

System administrators will preferably interact with the system on a daily basis for at least a few hours a day. They are typically responsible to making sure the system is running efficiently and without trouble. The system preferably provides facilities to report diagnostic information, as well as the status and configuration of system-wide parameters. System administrators preferably have at least one year of experience with IIS (Internet Information Server), ASP (Active Server Pages), HTML (Hypertext Markup Language) and SQL (Structured Query Language). System administrators are also able to perform all the functions of a client administrator for any client in order to provide full problem resolution support. System administrators can be located anywhere geographically with secure Internet access.

A client web master typically accesses the system on an as needed basis for an average of an hour per session. They are responsible for querying the system to generate the system's HTML, which is then incorporated on the client's web site(s) to invoke the operator request. The client web master preferably has at least one year of extensive web server, HTML and HTTP (Hypertext Transfer Protocol) experience, with administrative access to the client's web site. They can be located anywhere geographically with secure Internet access. Client web masters will have web master-level access to their specific client's profile.

### 2. User's Experience for Customer Support Live-Streamed Media Distribution

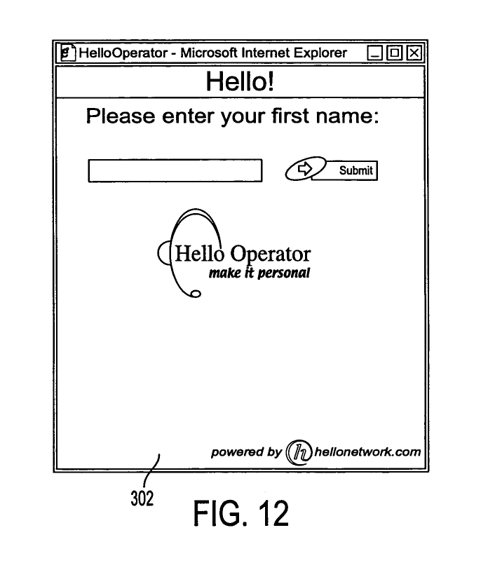

When customer support live-streamed media distribution is used in an electronic commerce World Wide Web site, the site will provide a Live Help hypertext link that pops up a new World Wide Web browser Window. With reference to FIGS. 11-14, in a welcome page 302 a user is typically prompted for a user name/chat handle of their choosing. In some variations of customer support live-streamed media distribution, the user name might be provided from typical e-commerce pages to which the user has already provided responses.

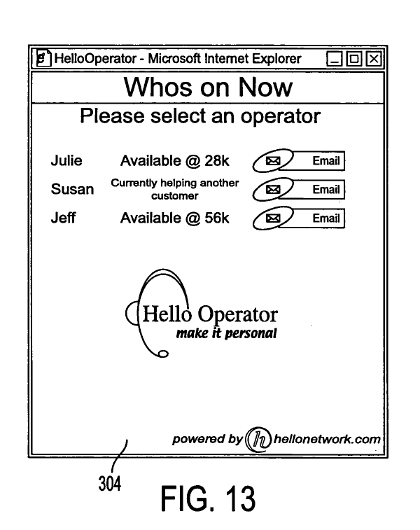

When the user name is determined, the user is provided with a “Who's on Now” page 304. The Who's on Now page provides the user with a list of Operators, and their availability. These operators will preferably be listed by name, and the list will include an indication of whether they are available (i.e., whether they are currently logged in to their broadcasting server and whether they are currently busy with another user). In particular, this software checks a pre-defined list of broadcast clients in an ongoing, real-time approach, to determine if they are logged in and available or not. If they are logged in and available, they are listed as such (see FIG. 13).

If the operator is in a private interactive session with another user, or if the operator is logged out, then the user will be provided with the capability to send the Operator an email message. In particular, if the named Operator is busy, the user can be presented with a client configurable message, and a client configurable leave message form. This form can them be sent to the Operator, or an assignee of choice configured by the client, using Electronic Mail.

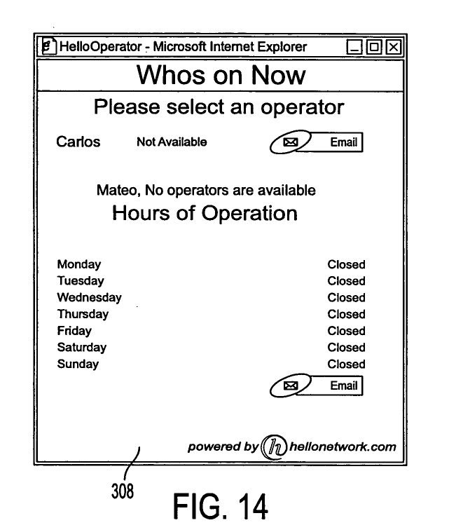

If no operator is available, then the user is preferably presented with client configurable message, and client configurable Leave Message Form. Preferably, the user is presented with the hours of operation 308 for the site (see FIG. 14).

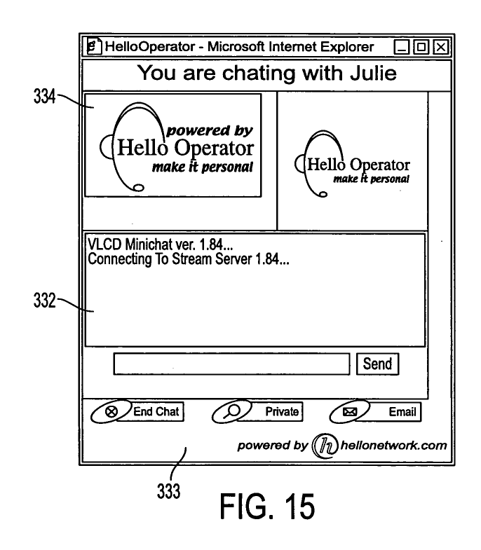

With reference to FIG. 15, upon choosing an available operator, the user is presented with a chat interface 332 on an operator chat page 333 to begin the “chat” session with the chosen operator. The chat session is operated in a “Forum”-type approach. In this approach, the operator has the ability to interface with more than one user at a time, while broadcasting media 334. Optionally, the client could configure the session as private, i.e., not using a forum-type approach (as discussed below).

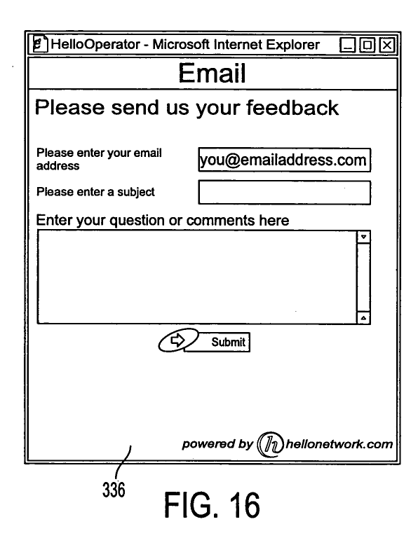

The user is presented with an interface that allows it to interactively type text that will be sent to the operator, preferably to be seen by both the users and the operator. The operator has the ability to see text from more than one user at this point, and has the ability to talk and/or type answers back to the users that are currently logged in with that particular operator. From this chat interface, each user preferably has a privacy button to request a private session with that operator for discussions of sensitive information, an email button to send an Email to that operator, and an end-chat button to end the session with that operator (see FIG. 16 for an email page 336).

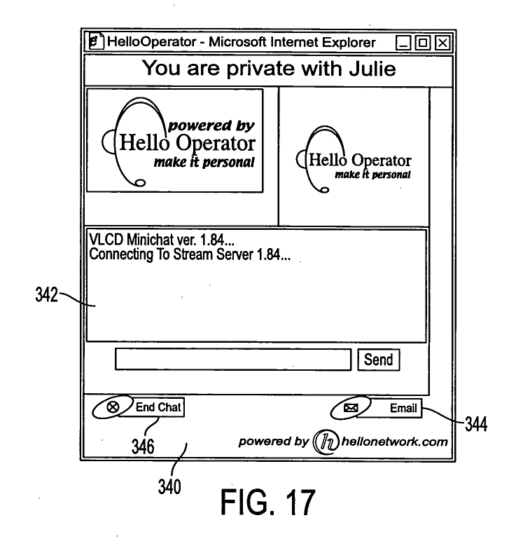

With reference to FIG. 17, upon choosing an operator's “Private” button on a Forum operator, the user is presented with a private interface 340 to begin the “chat” session with the chosen operator, in a “Private” type approach. The operator at this time has the ability to interface with one user at a time. The user is presented with an interface 342 that allows them to type text to the Operator. The operator has the ability to see one user at this point, and has the ability to talk and/or type answers back to the user that is currently logged in with that particular operator. The user has an email button 344 to send an email to that operator; and an end-chat button 346 to end the session with that operator (see FIG. 16 for an email page 336).

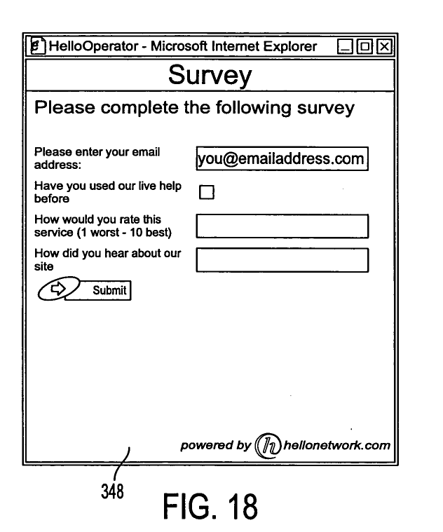

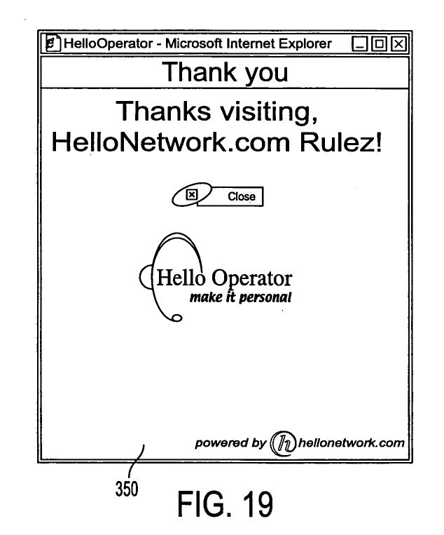

With reference to FIG. 18, when the user ends the session with an operator, it is preferably presented with a client configurable User Survey form 348. This form allows the client to collect pertinent information about the user-customer; the operator; the customers purchase preferences, and/or other information. As depicted in FIG. 19, upon completing the survey page, the user is presented with a banner page 350 that thanks it for its participation. This page is also client configurable.

### 3. Operator Control of Customer Support Live-Streamed Media Distribution

Operators will preferably be able to access either Private- or Forum-type messaging streams upon initial login. Thus, an operator will be able to either interface with a single user at a time (Private) or many users at a time (Forum). Additionally, the operator typically has the ability to: see a list of current users; select a user from list; send preformatted chat responses to users; send preformatted Uniform Resource Locations (URLs) to users (i.e., push content); reset a chat history that is otherwise maintained; terminate chat sessions; see a list of operators that are logged in; see the operator status; transfer a user to another operator; see the current system time; see a ‘last message received’ time; see a ‘last message sent’ time; enter ‘a last call mode’ (while finishing current session(s), this mode will not accept new user sessions and will indicate such to potential users seeking to establish a session); and receive an audible and/or visual indicator when a user enters or exits the forum.

### 4. Administration of Customer Support Live-Streamed Media Distribution

While operators will typically control individual media-stream content, administrators control the usage of customer support live-streamed media distribution. Administrators for customer support live-streamed media distribution are able to do the same functions as those for recorded media distribution. Administrators for customer support live-streamed media distribution are also able to do the following additional functions: CREATE A NEW OPERATOR, which adds a new operator to the list of operators available to the user on that web page; CREATE NEW ADMINISTRATOR, which adds another administrator account to the administration section, giving the new administrator the same capabilities as the existing administrator; LIST ALL OPERATORS AND STATUS, which views the current status of all operators (e.g., logged on; logged off, in a forum chat, or in a private chat); LIST ALL ADMINISTRATORS AND STATUS, which lists the status of all administrators (e.g., logged in; logged off); PRINT LISTS, which prints detailed reports regarding operators, administrators, users, and other vital statistical information, such as view session chat transcripts); EDIT/VIEW OPERATOR, which edits or views the status of an operator, allowing the administrator to change an operator from a forum to a private operator, or vice versa, or to terminate an operator's session; EDIT ADMINISTRATOR, which edits or views the status of an administrator, allowing the administrator to change an administrator to an operator, or vice versa, or to terminate an administrator's session; EDIT CHAT MESSAGE LIST, which changes the chat message that the user sees when entering a session with an operator; EDIT URL LIST, which edits the list of operator URLs available to the user; and otherwise customize the system.

### D. Streamed Media Email Transmission

An email-based media embodiment of the media transmission system may differ from the previously described embodiments in that its media source is more likely to be individual users. By using the streamed media email transmission's product and/or service, users can send other users email containing URLs that point to web pages providing streamed media content that can be viewed and/or listened to without the use of plug-in software.

Streamed media email transmission shares some aspects in common with the recorded media distribution. In particular, the recipient of the email subsequently loads a web page that uses a Java-enabled client dynamically loaded in the recipient's web browser, generally eliminating the needs to download, install, or maintain plug-ins or other downloaded software. Other aspects of the previously described embodiments can be used in conjunction with variations of streamed media email transmission.

Streamed media email transmission further provides for the sending user to prepare the media content and create the web page that is subsequently accessed by the email recipient. In particular, preferably the sending user is provided the ability to encode a binary media file that includes audio and/or video that the sending user has generated (e.g., from a camera), and then send the binary file to a server. An HTTP link is then sent, preferably by the sending user, to the recipient. The receiving user's activation of the HTTP link, e.g. by clicking on it, then streams the audio and video multimedia information to the recipient, removing the requirement for lengthy downloads of the encoded binary file.

### 1. The Sending User's Experience for Streamed Media Email Transmission

In this case, the user who intends to send a video email (i.e., the client) generally will first need to download the video email broadcast client software. Optionally, if adequate software exists on the sending user's machine, either no download or a minimal download can be made.

The broadcast software files are installed on the client machine, and appropriate registry entries are made to the client machine. Preferably, the client machine is running Windows 95, Windows 98, Windows NT or Windows 2000. The client machine preferably has a camera and/or installed either prior to installation of the broadcast client, or after installation of the broadcast client. The client machine is preferably connected to either the Internet or a corporate intranet.

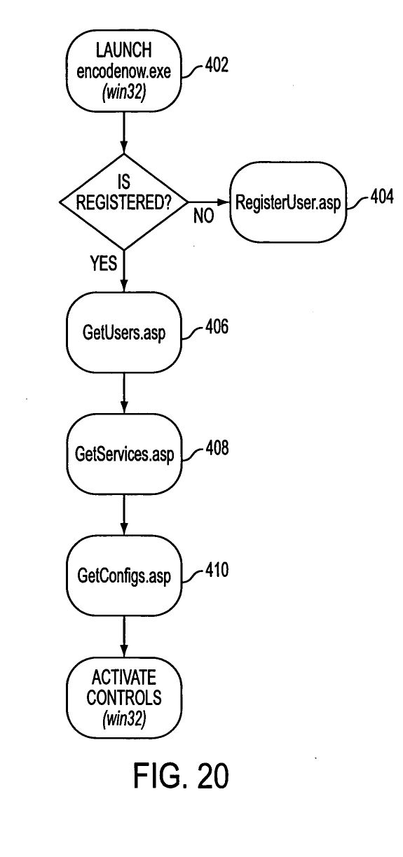

With reference to FIG. 20, once the broadcast client is installed, the broadcast client makes an Active Server Page call 402 to a server that it is previously programmed to contact upon completion of installation. This server call returns a HTML request to the broadcast client requesting information required for login and registration. The user enters this information before proceeding. If the user is not registered, then the user is directed to registration software 404. Once the user is identified as a registered user, the user's registration information is retrieved 406 and used to populate the services information of the database.

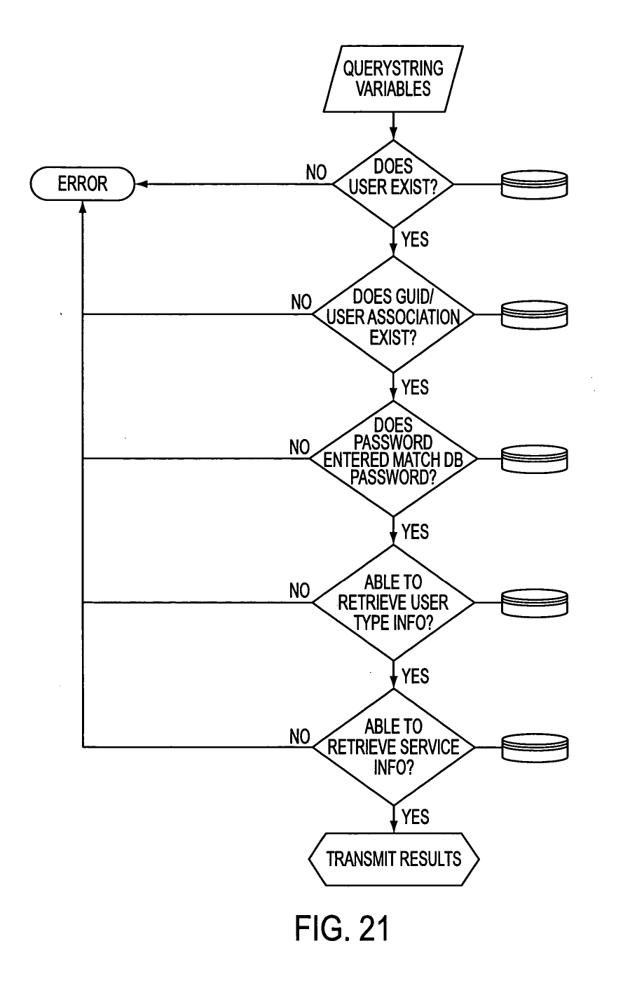

The client is then given a choice of services 408 to choose from. These services include: sending video email; uploading to server; and other server related administrative services. During this process, databases are checked to verify that the user and password exist and are correct, and that user information is available and retrievable (see FIG. 21).

Upon selecting appropriate services, the user is presented with an HTML Active Server Page that provides the user with a choice of options 410 covering additional video and audio configuration features. These options may include: control over height and width of client view area; control over frame rate; control over bandwidth to optimize; and control over maximum length in bytes and/or time.

Preferably, upon selecting a configuration, a record button on the broadcast client login screen is activated by an Active Server Page call from the pre-programmed server. Upon the user's pressing of the record button, the broadcast client encodes the audio and video inputs from the camera and/or microphone on the broadcast client machine in real time and stores them locally on the broadcast client. This encoding process involves both encoding and compression of the audio and video inputs from the broadcast client machine. The compression of these inputs facilitates the transmission of the file to the server, and then to the end users machine that eventually views the audio and video file.

The broadcast client will stop recording if: (1) the user intervenes by pressing a stop button; (2) the broadcast client reaches the maximum time previously set and stored on the server; or (3) the broadcast client reaches the maximum byte count previously set and stored on the server.

Alternatively, the user can be provided with other options to incorporate audio and/or video into the media.

Upon completion of media recording and/or generation as described above, a send button becomes activated on the screen. Upon the sending user's pressing the send button, the broadcast client makes a pre-defined Internet Server Application Programming Interface call to the pre-defined server. The Internet Server Application Programming Interface call determines whether this is a pre-approved upload as defined by the user in the installation process. The approval process may include requirements such as: (1) a unique upload identification number; and (2) a unique User Identification login.

Using this information, the broadcast client authenticates itself and, if authenticated, the Internet Server Application Programming Interface call to the server then begins an upload process. The upload process involves copying the preferably compressed and/or encoded media stream file to the pre-defined server where it is stored in a file system structure. A pointer to the stream media file is stored in a relational database environment on the pre-defined server. This stream media file is preferably comprised of both audio and video content. This completes the upload process.

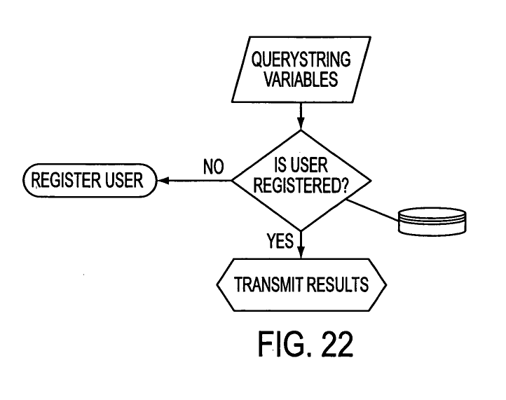

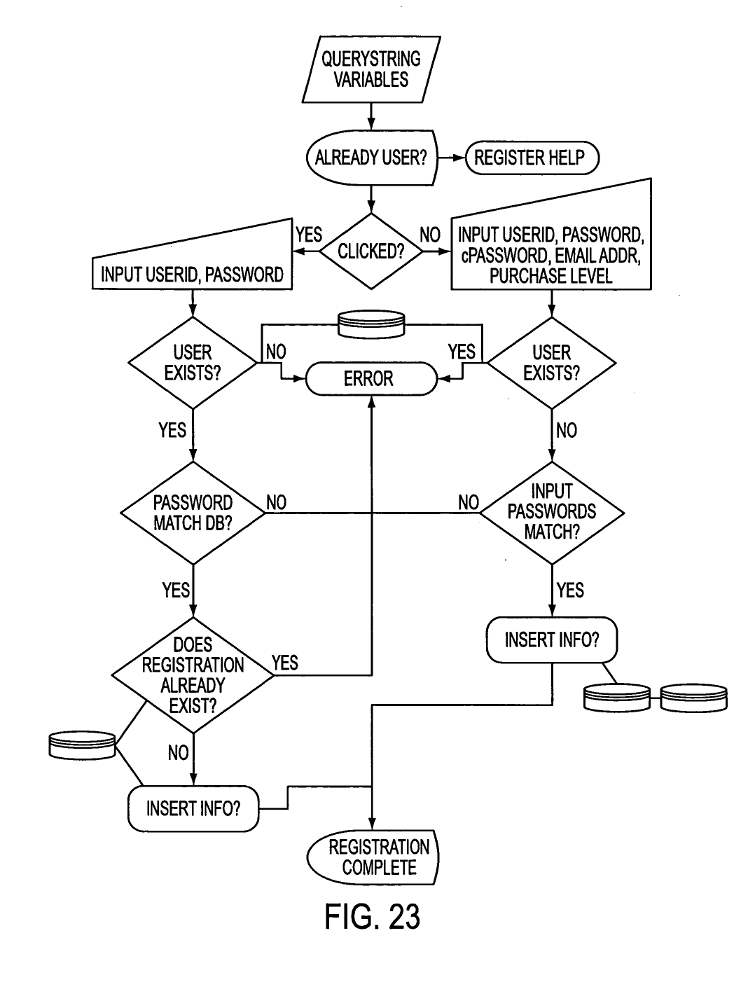

Upon successful upload of the media stream file, the broadcast client software preferably launches the broadcast client machine's previously set default Internet World Wide Web browser. This browser is sent a series of Active Server Pages to have the sending user provide additional information. As depicted in FIG. 22, the user is first verified. Then, as depicted in FIG. 23, the provided Active Server Pages will prompt the user through the process of providing the additional information to a video e-mail specific service previously chosen and stored on the pre-determined server farm.

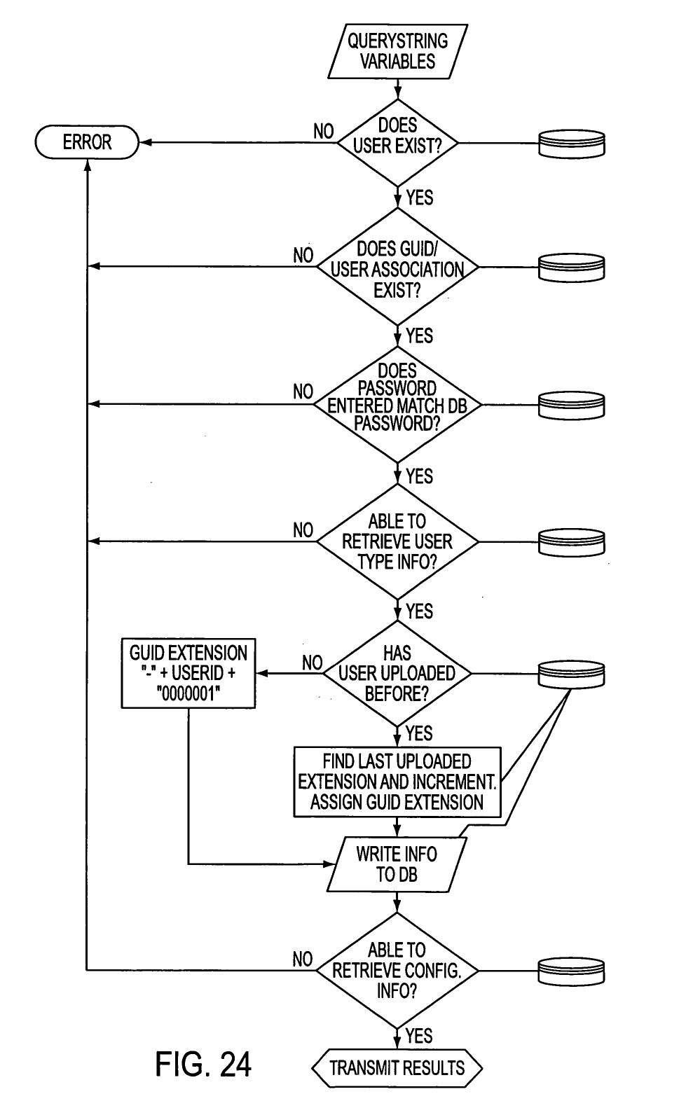

Under the process flow depicted in FIG. 24, after the uploading of the multimedia encoded file, the video email specific service information is requested. This information may include: recipient information; carbon copy information; blind carbon copy information; subject information; and message information.

The recipient information is the Internet Electronic Mail address of the primary person intended to receive the video email with the compressed multimedia file included. The recipient information provides a field of not more than 128 characters per the Internet Electronic Mail standards for recipient header information.

The carbon copy information includes the Internet Electronic Mail address of another intended recipient other than the primary recipient. The carbon copy information provides a field of not more than 128 characters per the Internet Electronic Mail standards for recipient header information.

The blind carbon copy information includes the Internet Electronic Mail address of another intended recipient other than the primary recipient. The blind carbon copy information provides a field of not more than 128 characters per the Internet Electronic Mail standards for blind carbon copy header information.

The subject field allows the user to provide a description of the message information content. The subject information provides a field of not more characters per the Internet Electronic Mail standards for subject header information.

Finally, the message information field is a free-form field where the user enters information pertinent to the overall message.

### E. Combination of the above Embodiments of the Media Transmission System

While the above embodiments of the media transmission system have been described individually, it is understood to be within the scope of the media transmission system to combine their usage. For example, it was previously mentioned that operators of customer support live-streamed media distribution could have the power to direct users to specific URLs of interest. These URLs could include web pages of recorded or live-streamed media distribution. Likewise, users of recorded, live-streamed, or customer live-streamed media distribution, or operators/broadcasters of the live-streamed, or customer live-streamed media distribution, could have the capability to use streamed media email transmission to further enhance the level of communication. Such combinations could have use in a wide variety of virtual environments, such as e-tail sales, online education, online entertainment, online group discussions or debates, and the like.

### II. The Web based Infrastructure

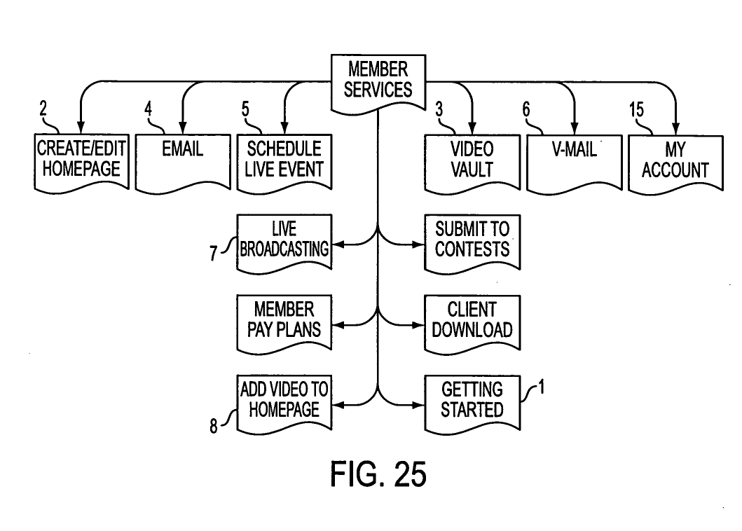

In FIG. 25, one implementation of a web-based infrastructure for supporting multimedia communications in a networked environment is depicted. The implementation is based upon a Member Services web page, which is part of a larger virtual architecture. The larger virtual architecture provides a membership option that offers benefits to members, including the ability to create and edit a home page that is accessible by others over the Internet. Reference numerals in this diagram relate to numbers in other figures, which provide further detail on various aspects of the embodiment. The term video, when used below, will refer to audio and/or video data.

### III. Multimedia Archive

### A. Multimedia Archive Features

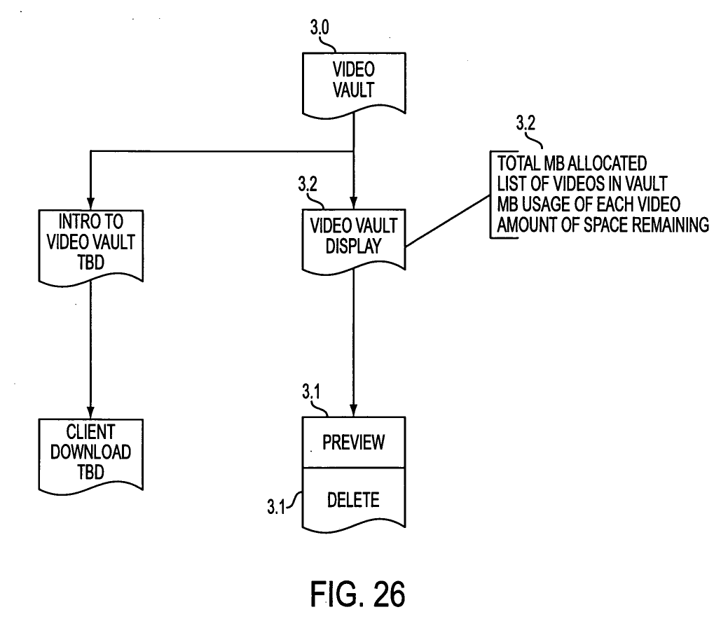

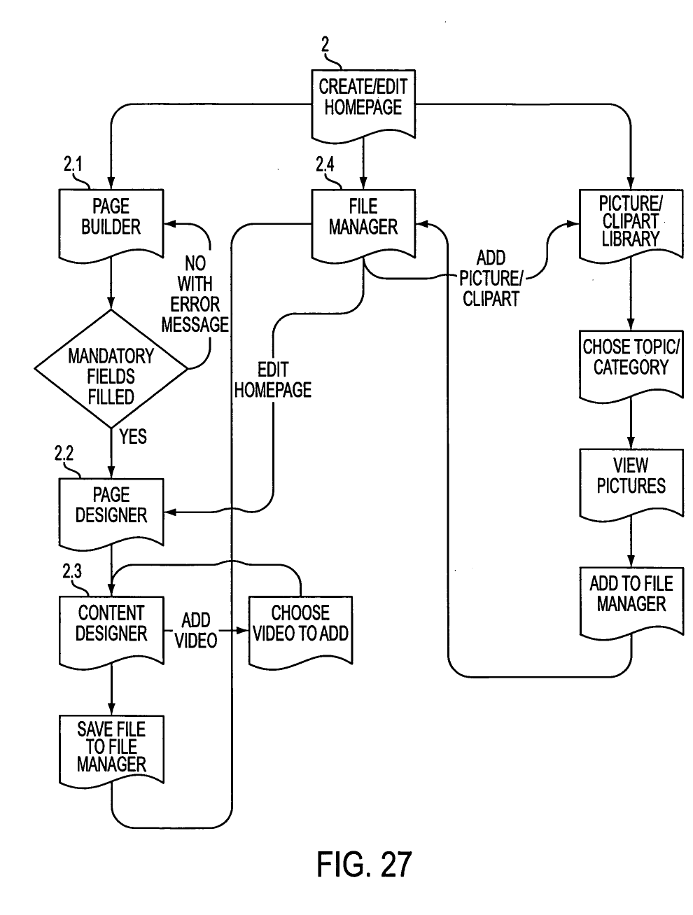

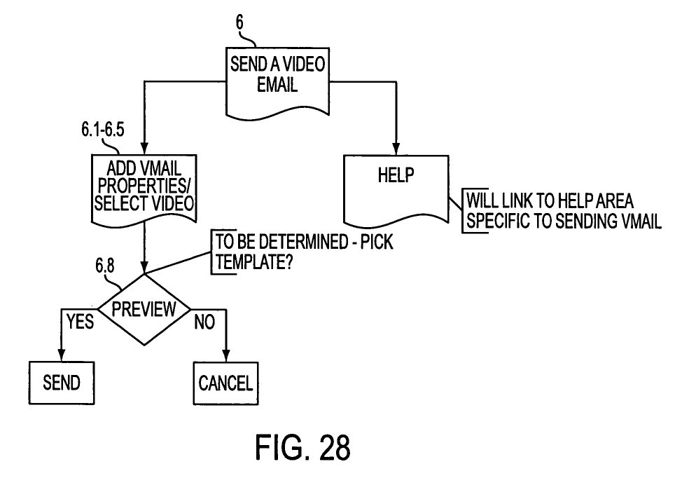

With reference to FIGS. 25-27, a user is able to record a multimedia file (audio and/or video) from the user's desktop PC, and upload the file to a space that has been reserved for the user in a system database as the user's multimedia archive. Users may be able to upload up to a predetermined number of megabytes of media content to their allocated space, preferably encoded under some type of CODEC (i.e., a compression/decompression algorithm). Users then visit the system's home page to access the multimedia archive. Member-users can access the multimedia archive in the following areas on the system: a Multimedia Archive page, a Video Email page, an Upload to Your Home Page, and a Submit to Contest page. Users can choose their video and upload to a given area via HTML pages on the system.

### B. Creation of a Video to be Stored in the Multimedia Archive

System members can record audio/video content, preferably encoded under a CODEC, via software available through the Internet. A member uploads created audio/video content by choosing a “upload video” option in the application. Once the uploading successfully completes, the software returns a message of “video successfully uploaded.”

An exception to this occurs when the member loses the Internet connection, causing the software to return a message telling user that connection cannot be established. Another exception to this occurs when a member exceeds their allocated multimedia archive storage capacity, causing the software to return a message telling the user its file exceeds their storage allotment, and prompts the user to view the multimedia archive FAQ.

### C. Accessing the Audio/Video Contents of a Multimedia Archive

Members can access the multimedia archive page from Member Services. As an alternative, members can accesses the multimedia archive page directly from The member services page.

Members can choose to view or delete any video displayed in their multimedia archive (viewed as a scrollable list within any page containing media archive information). On every instance of the multimedia archive display, the page will show a member their current video file size information and the remaining amount of storage available to them. The page will contain information about the various ways the members can use their video. It will provide tips for creating compelling content, etc. The page will contain links to “Send a Video Email,” “Upload a Video to Your Home Page,” and “Submit a Video to a Contest” pages.

### D. Uploading a Video from a System Home Page using the Multimedia Archive

Members can access the “Add Video to Your Home Page” section from the Create/Edit Home Page. Alternately, members can access the Add Video page directly from the Member Services page.

Members can choose the video they wish to upload from a scrollable list. Members can view or delete videos from the scrollable list. A member selects an “Upload Video” button, and the page returns, “Your video has been added to your home page.” If a member currently has a video on their home page, the new video submission will replace existing video. An exception to this occurs if the video submitted causes the member's homepage to exceed allotted home page storage capacity, the page returns message informing user that they cannot upload new video due to storage capacity, and prompts them to view the Home Page FAQ. Another exception occurs if the member does not choose a video before submitting, page returns an error saying “Please select a video to upload.”

### E. Sending Video Email using the Multimedia Archive

Members can access the Send Video Mail page from Member Services.

A member chooses the video they wish to send from scrollable list. The member can view or delete videos from scrollable list. The member enters information in To, From, Subject, and Message fields. The member then previews the Video Mail by choosing a Preview button. The member sends Video Mail by choosing “Send Video Mail” button. Page returns “Video Mail successfully sent.”

An exception occurs if the member has used the maximum amount of Video Emails allowed through their membership plan. In that case the page returns message informing member they must increase their Video Mail capacity, and prompts them to view the Video Email FAQ page. Another exception occurs if the member does not choose a video before submitting, which then causes the page to return an error saying, “Please select a video to upload.” Yet another exception occurs if the member has no video content stored in their multimedia archive, causing the page to return an error saying, “You currently have no video files in your Vault. Click here for more information on creating video content.”

### F. Submitting a Video to a Contest

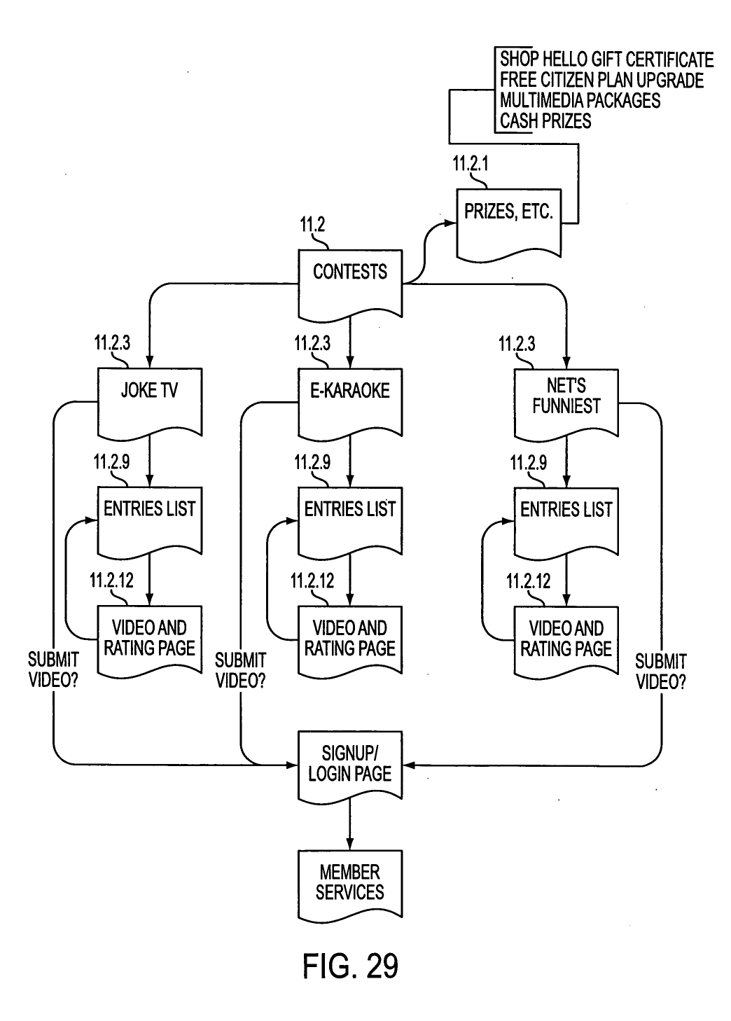

With reference to FIGS. 25 and 29, members can access a Contest page from the Member Services page, choosing a video to upload from scrollable list.

A member can view or delete videos from the scrollable list. Member selects a contest (e.g., “Joke TV”) via a radio button. The member selects a “Submit my video” button, and the page returns, “Your video has been submitted to the Contest. You will be informed via email if you have won.” An exception occurs if the member submits the same video more than once to the same contest. In that case, the page returns an error message stating, “You may only submit your video once.” Another exception occurs if the member does not choose a video before selecting to submit, in which case the page returns an error stating, “Please select a video to upload.”

### IV. Video Capture

By using the video capture process, integrated with the multimedia archive service with File Manager, users of the electronic media will be able to create, store, retrieve, and manage their multimedia files in an easier, friendlier, more consumer and business oriented manner. This process makes E-commerce user-friendlier by providing businesses and consumers the ability create their multi-media files in a manner that provides quick and easy access to each multimedia file in the multimedia archive. In addition, it provides an easy method for loading the multimedia files into the multimedia archive.

### A. Stream Creation Features

Users are able to record a multimedia file from their desktop PC, and upload tile file to a space in the system database reserved for the user (their multimedia archive). Users will be able to upload up to a predetermined number (x) of megabytes of media content to their allocated space.

### B. Opening the Software

Initially, a user opens the software, preferably from its own computer's hard drive or local area network via an icon shortcut, or via the Program Files windows menu. The software returns a page with fields for the user to enter a System membership name and password. The user successfully enters the requested information and selects a “Log In” button. The software gives a “Connecting” type message while it verifies the entered information. After the software successfully verifies the user's name and password information, the software then displays full functionality.

An exception occurs when the user has not established an online connection. The software then returns an error message saying, “Cannot locate server. Please verify you are connected to the Internet, and try again.” Another exception occurs when the user did not enter information in one or both fields. The software then returns an error message saying, “Please enter your member Name (or Password)”. Yet another exception occurs when the user enters the name or password information incorrectly. The software then returns an error message saying, “Cannot verify account. Please check that you have entered your information correctly and try again. If you believe you have received this message in error, please email our support group at . . . .”

Upon opening the stream creation software, the user is prompted to enter a membership name and password. Upon confirmation, the stream creation software is launched. The software's graphical user interface has three tabs, one for live media, one for recorded media, and one for receiving help. Users can select the appropriate tab to display the info related to each action.

### C. Live Media

### 1. The User Streams Live Video Content

After the user successfully opens the software and logs in, the user can select the Broadcast Live tab. The software then displays the information related to the live functionality. The software prompts the user to choose the properties of the video stream. The user can choose from 56.6 k, or 28.8 speed, and one or more (preferably two) picture sizes. The user can adjust brightness, contrast, saturation, and hue of their video. The user can block other users from viewing via a Viewers button. Users can log into their stream via a Start Broadcast button, and log out via an End Broadcast button. Thus, the software offers the following buttons: (a) video window; (b) video statistics area (displays .sbm size/bandwidth/picture size); (c) “Please choose your video properties before broadcasting” text; (d) radio buttons for user to choose 56.6 k or 28.8 k bandwidth; (e) radio buttons for user to choose picture size; (f) adjust video button; (g) start broadcasting button; (h) end broadcast button; (i) viewers button; and (j) go to home page world button.

After selecting the preferred settings, the user selects “Start Broadcasting” and successfully logs into a stream. An exception occurs if the user loses Internet connectivity. Then, the software returns error message saying “Cannot locate server. Please verify you are connected to the Internet, and try again.” Another exception occurs if the user has exceeded the maximum number of broadcast hours. The software then returns an error message stating: “You have exceeded the amount of broadcast time available to you. Please visit the system home page for more information on increasing your broadcast hours.”

### 2. Viewing and Blocking Other Users

For this function, the user chooses the Viewers button. The software paints a new window allowing user to view user chat handles & IP addresses. The user may elect to block viewers at the window.

### 3. Selecting to go to System Home Page Button

The software launches a browser window that connects to the system home page. The user is then automatically logged into the H-W system. An exception occurs if the user loses Internet connectivity. The software then returns an error message saying, “Cannot locate server. Please verify you are connected to the Internet, and try again.”

### D. Recorded Media

After the user successfully opens the software and logs in, the user can select the Recorded Media tab. The software then displays the information related to the recorded functionality. The software prompts user to choose their stream properties. The user can choose from 56.6 k or 28.8 k speed or higher such as ISDN, DSL, and Cable Modem speeds, and one or more (preferably two) picture sizes. The user can adjust brightness, contrast, saturation, and hue of the video. The user can start recording via a Start Recording button, and stop recording via a Stop Recording button. The user can view the video via a Play Video button. The user can save the .sbm files to a reserved area on the System database via an Upload to multimedia archive button.

### 1. Opening The Software

The user opens the software via an icon shortcut or by opening Program Files/Application. The software returns a page with fields for user to enter their name and password. After the user successfully enters information and selects a “Log In” button, the software gives a “Connecting . . . ” type message while it verifies information. Once the software successfully verifies user name and password information, it then displays full functionality.

An exception occurs if the user has not established an online connection. The software then returns an error message saying, “Cannot locate server. Please verify you are connected to the Internet, and try again.” Another exception occurs if the user did not enter information in one or both fields. The software then returns an error message saying, “Please enter your member Name (or Password).” Another exception occurs if the user entered a name or password incorrectly. The software then returns an error message saying “Cannot verify account. Please check that you have entered your information correctly and try again. If you believe you have received this message in error, please email our support group at . . . .”

### 2. Recording Video Content

After the user successfully opens software and logs in, the user selects the Record Video tab. The software then displays the information related to the Recording functionality. This information includes the following items: (a) video window; (b) video statistics area (displays .sbm size/bandwidth/picture size); (c) “please choose your video properties before recording” text; (d) radio buttons for user to choose 56.6 k or 28.8 k bandwidth or at higher speeds appropriate for DSL and Cable Modems, for example; (e) radio buttons for user to choose picture size; (f) adjust video button; (g) start recording button; (h) stop button; (i) play button; () upload to video vault button; and (k) go to the home page button.

The user starts recording video by selecting the start recording button. User ends video recording by selecting stop button. After the recording is finished, the software displays information on total file size/bandwidth/picture size.

### 3. Adjusting Video Quality

The user chooses the Adjust Video button. The software paints a new window with the following adjustable settings: brightness, contrast, hue, and saturation. The user makes settings changes, and selects Save Changes button. The user is then returned to the home page.

### 4. Previewing Recorded Video Content

Upon completion, the user has successfully recorded a video clip. The user can then select the Play Video button. Upon doing so, a video window displays the recorded video content. An exception occurs if the Play Video button is selected when no video has been recorded. No action then occurs.

### 5. Uploading the Video to the System

After the user has successfully recorded a video clip, the user selects “Upload to multimedia archive.” The software returns an “Uploading . . .” type message. The software successfully uploads the media file, and returns, “Your video is now saved in your multimedia archive. You can now access the system home page to use your video services.” An exception occurs if the user loses Internet connectivity. The software then returns an error message saying, “Cannot locate server. Please verify you are connected to the Internet, and try again.” Another exception occurs if the member has exceeded their allocated multimedia archive storage capacity. The software then returns an error message: “The video you are attempting to upload exceeds your multimedia archive storage capacity. Please refer to the multimedia archive FAQ for information on increasing your video storage.”

### 6. The User Selects go to System Home Page Button

Finally, the user selects the Go To System button and the software launches a browser window that connects to the system. The user is automatically logged into the system. An exception occurs if the user loses Internet connectivity. The software then returns an error message saying, “Cannot locate server. Please verify you are connected to the Internet, and try again.”

### E. The Help Section

The Help section of the software will have a windows-type help area that is searchable, with contents and an index.

### V. Network Architecture

By using a network architecture, large numbers of broadcasters and viewers will be able to send and receive multimedia audio streams, both live and recorded, in a highly reliable manner. There are five main objectives that are preferably met with this network: (1) Reliable-name brand, fault-tolerant equipment should be used; (2) High end-quick response time to end-users; (3) Consistent-the exact model/version should be available for at least one year after initial purchase; (4) Expandable-the systems should scale with just the addition of memory, CPUs, and storage; (5) Software Support-all software works well with custom ISAPI/Java software that is used to stream real time video.

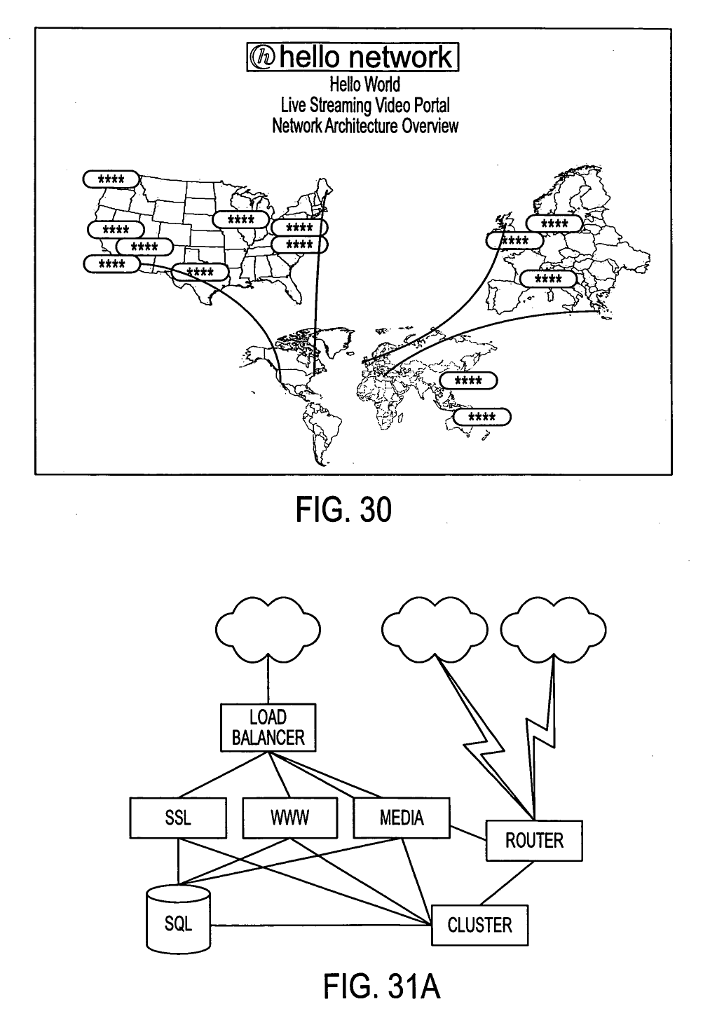

As depicted in FIG. 30, the network will preferably be replicated at multiple data centers throughout the continental United States and the world. A centralized Network Operations Center will be built to manage this on a worldwide basis. This network has the capability of replicating the SQL and binary data between data centers in a near-real-time basis, as well as reinforcing referential integrity for E-Commerce transactions across all data centers in real-time via two-phased commit transactions. In addition to the Internet, an asynchronous transfer mode (ATM) DS3 virtual private network (VPN) will be added between all data centers and the Network Operations Center to provide an additional layer of redundancy above and beyond the Internet.

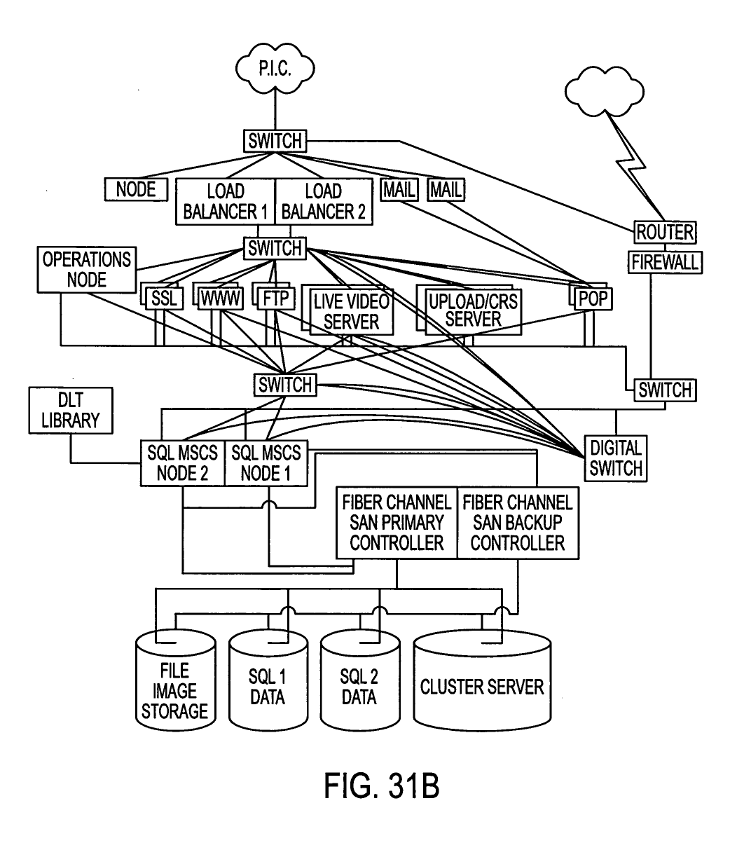

With reference to FIG. 31A, the data centers typically include three types of servers, an SSL (Secure Sockets Layer) Transactional Server, a WWW (World Wide Web) web page server, and a Media Streaming Server. Each of these three server types serves a different function (described below), and preferably includes a plurality of redundant servers, providing both system fault tolerance and increased load capacity. Each of these server types also connects to an SQL Cluster of servers, providing database services to store membership information, the video vault, and other relevant data.

The transactional, web page, and media streaming server types all connect to the Internet through a primary connection accessed by a load balancer. The load balancer directs incoming streams of data packets to the appropriate type of server from among the three server types. It further monitors the load carried by each of the redundant servers of any given type, and routes new streams of data packets accordingly to balance the load between the redundant servers.

The web page servers support all of the web pages, as described above. Users interact with the web pages to register as members, create and edit homepages, send video mail, schedule live events or broadcasting, download media files, submit entries to contests, and the like. The web page servers connect to the SQL Cluster in order to complete these functions.

The transactional servers receive requests for streamed media from video mail recipients, people requesting live broadcasts, and the like. Using a connection to the SQL cluster, the transactional server identifies the media stream, verifies the requester's access rights (if necessary), and transmits instructions to have the media stream created and transmitted to the requester.

Upon receiving verified instructions to have the media stream created and transmitted to the requester, the media streaming server, which also has a connection to the SQL Cluster, receive the media stream and generates a data stream containing both the media and the media player code. If the requester is in a location best served by that particular data center, then the data stream is sent out through the load balancer to the Internet. However, if there is another data center that is better positioned with respect to the requester, then the Streaming server sends the data stream through a router and a private network to a data center selected as the preferred to transmit to the requester.

Turning to the details of each point of presence (POP) data center, With reference to FIG. 31B, the POP platform may be implemented with Windows NT. Web pages are built dynamically from the IIS as ASP pages, with the content coming from a fault tolerant content cluster. Each POP is redundantly connected to the Internet via at least two different ISPs. Load balancing hardware distributes requests to clusters of logical servers. SMTP e-mail servers are outside of the protection of the load balancing hardware in the “DMZ” to minimize attacks such as DOS or mail bomb attacks on the operational POP server farm.

The POP Logical Server Clusters are logical groupings of servers that make up logical cluster types. Each logical server cluster is designed to be fault tolerant, and independent of all other logical server clusters with respect to problems. A front line cluster is composed of “content” servers. As the need for increasing the cluster size arises, the individual functions may be broken out to multiple clusters themselves. These individual services include: standard World Wide Web calls (e.g. HTML) and streaming video calls.

Streaming media calls (Images & Video) is for the images and recorded video portion of the multimedia files. The streaming media calls for live streamed-media distribution are directed to the live cluster and handled there. For security and manageability an SSL cluster are separate from the other clusters. A live cluster is for providing live multimedia streaming. The live cluster performs a two-way communication with a live broadcast client, and takes in a broadcast stream, and then dispenses that stream to the viewer community. A SQL Cluster provides a data storage repository for the recorded videos, and other required storage requirements. This storage is in a Storage Area Network (SANS) configuration, configured as a shared storage array.

### Hardware Overview

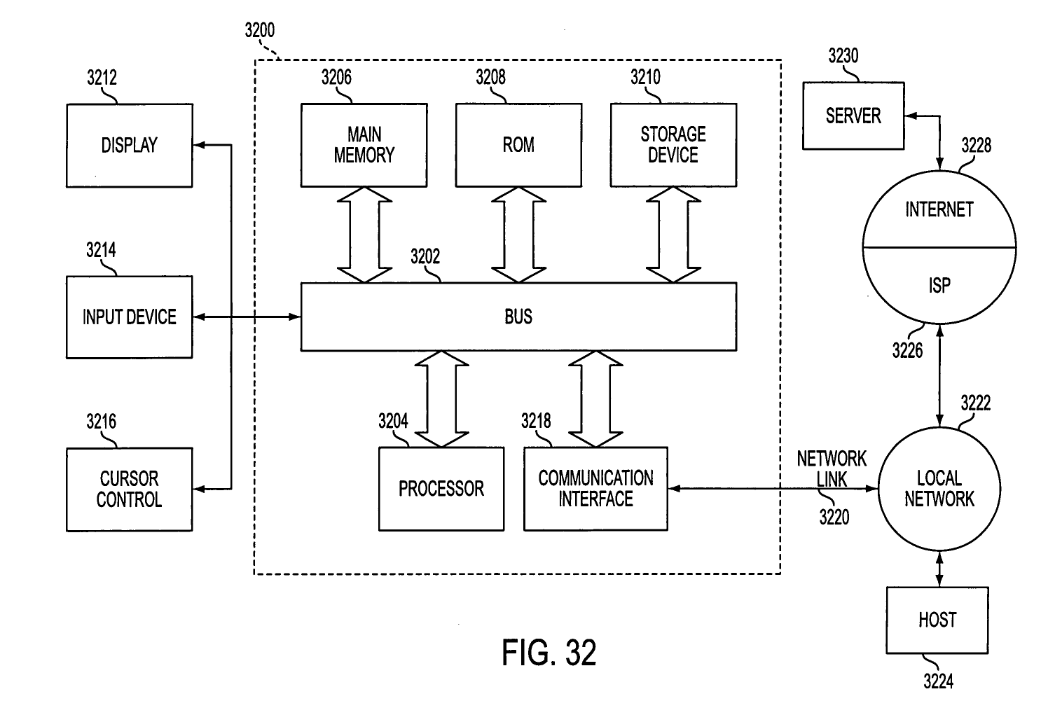

FIG. 32 is a block diagram that illustrates a computer system 3200 upon which an embodiment of the invention may be implemented. Computer system 3200 includes a bus 3202 or other communication mechanism for communicating information, and a processor 3204 coupled with bus 3202 for processing information. Computer system 3200 also includes a main memory 3206, such as a random access memory (RAM) or other dynamic storage device, coupled to bus 3202 for storing information and instructions to be executed by processor 3204. Main memory 3206 also may be used for storing temporary variables or other intermediate information during execution of instructions to be executed by processor 3204. Computer system 3200 further includes a read only memory (ROM) 3208 or other static storage device coupled to bus 3202 for storing static information and instructions for processor 3204. A storage device 3210, such as a magnetic disk or optical disk, is provided and coupled to bus 3202 for storing information and instructions.

Computer system 3200 may be coupled via bus 3202 to a display 3212, such as a cathode ray tube (CRT), for displaying information to a computer user. An input device 3214, including alphanumeric and other keys, is coupled to bus 3202 for communicating information and command selections to processor 3204. Another type of user input device is cursor control 3216, such as a mouse, a trackball, or cursor direction keys for communicating direction information and command selections to processor 3204 and for controlling cursor movement on display 3212. This input device typically has two degrees of freedom in two axes, a first axis (e.g., x) and a second axis (e.g., y), that allows the device to specify positions in a plane.

The invention is related to the use of computer system 3200 for multimedia network transmission. According to one embodiment of the invention, multimedia network transmission is provided by computer system 3200 in response to processor 3204 executing one or more sequences of one or more instructions contained in main memory 3206. Such instructions may be read into main memory 3206 from another computer-readable medium, such as storage device 3210. Execution of the sequences of instructions contained in main memory 3206 causes processor 3204 to perform the process steps described herein. One or more processors in a multiprocessing arrangement may also be employed to execute the sequences of instructions contained in main memory 3206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 3204 for execution. Such a medium may take many forms, including but not limited to, non-volatile media, volatile media, and transmission media. Non-volatile media include, for example, optical or magnetic disks, such as storage device 3210. Volatile media include dynamic memory, such as main memory 3206. Transmission media include coaxial cables, copper wire and fiber optics, including the wires that comprise bus 3202. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 3204 for execution. For example, the instructions may initially be borne on a magnetic disk of a remote computer. The remote computer can load the instructions into its dynamic memory and send the instructions over a telephone line using a modem. A modem local to computer system 3200 can receive the data on the telephone line and use an infrared transmitter to convert the data to an infrared signal. An infrared detector coupled to bus 3202 can receive the data carried in the infrared signal and place the data on bus 3202. Bus 3202 carries the data to main memory 3206, from which processor 3204 retrieves and executes the instructions. The instructions received by main memory 3206 may optionally be stored on storage device 3210 either before or after execution by processor 3204.

Computer system 3200 also includes a communication interface 3218 coupled to bus 3202. Communication interface 3218 provides a two-way data communication coupling to a network link 3220 that is connected to a local network 3222. For example, communication interface 3218 may be an integrated services digital network (ISDN) card or a modem to provide a data communication connection to a corresponding type of telephone line. As another example, communication interface 3218 may be a local area network (LAN) card to provide a data communication connection to a compatible LAN. Wireless links may also be implemented. In any such implementation, communication interface 3218 sends and receives electrical, electromagnetic or optical signals that carry digital data streams representing various types of information.

Network link 3220 typically provides data communication through one or more networks to other data devices. For example, network link 3220 may provide a connection through local network 3222 to a host computer 3224 or to data equipment operated by an Internet Service Provider (ISP) 3226. ISP 3226 in turn provides data communication services through the worldwide packet data communication network, now commonly referred to as the “Internet” 3228. Local network 3222 and Internet 3228 both use electrical, electromagnetic or optical signals that carry digital data streams. The signals through the various networks and the signals on network link 3220 and through communication interface 3218, which carry the digital data to and from computer system 3200, are exemplary forms of carrier waves transporting the information.

Computer system 3200 can send messages and receive data, including program code, through the network(s), network link 3220, and communication interface 3218. In the Internet example, a server 3230 might transmit a requested code for an application program through Internet 3228, ISP 3226, local network 3222 and communication interface 3218. In accordance with the invention, one such downloaded application provides for multimedia network transmission as described herein. The core may be executed by processor 3204 as it is received, and/or stored in storage device 3210, or other non-volatile storage for later execution. In this manner, computer system 3200 may obtain application code in the form of a carrier wave.

While this invention has been described in connection with what is presently considered to be the most practical and preferred embodiment, it is to be understood that the invention is not limited to the disclosed embodiment, but on the contrary, is intended to cover various modifications and equivalent arrangements included within the spirit and scope of the appended claims.

1. A method of compressing a media signal, comprising: processing the media signal to increase a number of null blocks in the media signal,
wherein a difference between corresponding null blocks of preceding frames is zero; and
replacing each of the null blocks in the media signal with a single bit having a first value.

2. The method according to claim 1, further comprising:
appending a bit having a second value other than the first value to a block in the media signal that is not one of the null blocks.

3. The method according to claim 1, wherein the null block is a 16×16 pixel block.

4. The method according to claim 1, wherein said processing the media signal includes performing an image stabilization analysis on the media signal.

5. The method according to claim 4, wherein said performing the image stabilization analysis includes:
identifying a block in the media signal that differ from a corresponding block on the preceding frame by an offset; and
replacing the identified block with a null block and an indication of the offset.

6. The method according to claim 1, wherein said processing the media signal includes:
applying a hysteresis filter to the media to identify a noisy block, wherein a result of the hysteresis filter for the noisy block falls below a hysteresis threshold;
replacing the noisy block with a null block and an indication of noise.

7. The method according to claim 1, further comprising encrypting the media signal based on a network identifier of a media source computer system.

8. A computer-readable medium bearing instructions for compressing a media signal, said instructions being arranged to cause one or more processors upon execution thereof to perform the steps of the method according to claim 1.

9. A method of compressing a media signal, comprising:
processing the media signal to increase a number of null blocks in the media signal, wherein a difference between corresponding null blocks of preceding frames is zero;
replacing each of the null blocks in the media signal with a first value, said first value being represented by one or more bits; and
appending a second value other than the first value to a block in the media signal that is not one of the null blocks, said first value being represented by one or more bits.

10. A computer-readable medium bearing instructions for compressing a media signal, said instructions being arranged to cause one or more processors upon execution thereof to perform the steps of the method according to claim 9.

11. A method for decompressing a media signal comprising:
replacing a specified bit in the media signal with a null block if the specified bit has a first value, wherein the null block represents a zero difference between corresponding null blocks of preceding frames; and
converting the null block into a non-null block.

12. The method according to claim 11, further comprising:
discarding the specified bit in the media signal if the specified bit has a second value other than the first value.

13. The method according to claim 11, wherein the null block is a 16×16 pixel block.

14. The method according to claim 11, wherein said converting the null block includes performing an inverse image stabilization analysis on the media signal.

15. The method according to claim 14, wherein said performing the inverse image stabilization analysis includes:
determining an offset for the null block; and
shifting the null block by the offset.

16. The method according to claim 11, wherein said converting the null block includes:
determining whether an indication of noise is associated with the null block; and
adding noise to the null block.

17. The method according to claim 11, further comprising decrypting the media signal based on a network identifier of a media source computer system.

18. A computer-readable medium bearing instructions for decompressing a media signal, said instructions being arranged to cause one or more processors upon execution thereof to perform the steps of the method according to claim 11.

19. A method of decompressing a media signal, comprising:
replacing a specified first value in the media signal with a null block, wherein the null block represents a zero difference between corresponding null blocks of preceding frames and the first value is represented by one or more bits;
discarding a second value, other than the first value, in the media signal, said second value being represented by one or more bits; and
converting the null block into a non-null block.

20. A computer-readable medium bearing instructions for decompressing a media signal, said instructions being arranged to cause one or more processors upon execution thereof to perform the steps of the method according to claim 18.
